(19) United States
(12) Patent Application Publication
(10) Pub. No.: US 2013/0238441 A1
(43) Pub. Date: Sep. 12, 2013

(54) Method and Apparatus For Social Telematics

(71) Applicant: Alexander Flavio Panelli, Palo Alto, CA (US)

(72) Inventor: Alexander Flavio Panelli, Palo Alto, CA (US)

(21) Appl. No.: 13/603,344

(22) Filed: Sep. 4, 2012

Related U.S. Application Data
(60) Provisional application No. 61/530,369, filed on Sep. 1, 2011.

(51) Int. Cl. B60Q 1/50

(52) U.S. Cl. CPC B60Q 1/503
USPC 705/14.62; 340/468

(57) ABSTRACT

In a first embodiment, the present invention permits an occupant of a vehicle to enter a message, with a handheld communications device having Wide Area Network (WAN) capability, and to have the message externally displayed for reading by persons who are not occupants of the vehicle. The message is displayed by an on-board telematic unit. In addition to a display, the telematic unit can contain a variety of sensors and/or effectors. Sensor readings from a vehicle X can be updated, approximately continuously, in a record (of a vehicle-oriented database) that stores information particular to vehicle X. The vehicle-oriented database can provide an open Application Programming Interface, in order to serve as a platform for a wide variety of application programs (or Apps). An App is presented that permits a person to contact the occupants, of a vehicle X, based only upon information from vehicle X's license plate.

As provided for under 35 U.S.C. §119(e), this patent claims benefit of the filing date of the following U.S. Provisional Application, herein incorporated by reference in its entirety:

“Method and Apparatus For Social Telematics,” Application No. 61530369, filed Sep. 1, 2012.

### FIELD OF THE INVENTION

The present invention relates generally to telematics, and more particularly to telematics that enhance social interaction.

### BACKGROUND OF THE INVENTION

Computer-based social media applications, such as FACEBOOK and TWITTER, are well known. While such social media has been adapted for use on mobile devices, such as cell phones with a capability for executing application software (also referred to as “Smart Phones”), social media has not been adapted to the unique challenges and opportunities posed by communication with and/or between the occupants of vehicles.

In general, telematics refers to any type of system, incorporating telecommunications and/or information processing, that has been specifically adapted for a vehicular environment. Telematic systems, developed to date, suffer from some combination of at least the following limitations:
no social media capability
special purpose
closed platform

An example special purpose system is a GPS navigation device. An example telematic system with a broader range of services is “ONSTAR” from General Motors (GM). OnStar, however, provides no social media capability and is a closed platform. For the first 15 years of its use, OnStar was an extremely closed system, since it was available only for vehicles manufactured by GM. Recently, GM has permitted use of OnStar on non-GM vehicles, in a new product offering called “OnStar For My Vehicle” (or OnStar FMV). While not as tightly closed as before, OnStar FMV is still a closed system since GM is the only service provider and the only manufacturer of the on-board OnStar FMV units.

It would therefore be desirable to have new telematic systems with some combination of the following advantages:
social media capability
broad purpose
open platform

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1A shows (in perspective view) a license plate frame 110, mounted on the rear of a vehicle 100, that has been equipped with a display unit 111.

FIG. 1B is essentially the same as FIG. 1A, but from a “flat” rear-view perspective.

FIG. 1C shows a front-mounted license plate frame 130 including a display unit 131.

FIG. 1D depicts a side view of vehicle 100 that shows, in addition to license plate frame 110, a handheld WAN communications device 120, front-mounted license plate frame 130, and front-passenger-compartment-mounted telematic unit 112.

FIGS. 2A-2B are essentially the same as, respectively, FIGS. 1A-1B, except telematic display unit 114 is mounted on (or incorporated into) the rear-bumper of a vehicle.

FIG. 2C is essentially the same as FIG. 2B, except that FIG. 2C shows a telematic display unit 114 that can be viewed through a vehicle's rear window.

FIG. 3A depicts a configuration in which just the on-board telematic devices 110, 130, and 112 (but not handheld WAN communications device 120) are connected to WLAN 320.

FIG. 3B shows gateway unit 112 providing a connection to a WAN and also shows handheld WAN communications device 120 as having a connection to a WAN.

FIG. 3C depicts a configuration in which the handheld WAN communications device 120 (and not just the on-board telematic devices) is also connected to WLAN 320.

FIG. 3D depicts the fact that there is no need for the use of a LAN, to achieve communication between handheld WAN communications device 120 and any of the on-board telematic units.

FIG. 3E shows that only a single WAN connection, provided by handheld WAN communications device 120, can be shared by both the handheld WAN communications device and the vehicle's telematic units.

FIG. 4A depicts a close-up view of a rear-mounted license plate frame 110.

FIG. 4B shows a close-up view, of another version of license plate frame 110, that includes a second display 420.

FIG. 4C depicts a close-up view of front-mounted license plate frame 130.

FIG. 5A depicts an example hardware implementation of a rear-mounted telematic unit 110.

FIG. 5B depicts an example hardware implementation of gateway and/or systems-monitoring telematic unit 112.

FIG. 6A shows an example basic structure for a centralized data and communication center (or “hub”) 300.

FIG. 6B shows an example vehicle-oriented database 601, where a vehicle identifier can serve as a primary key, for hub 300.

FIG. 7A illustrates the scenario where the non-occupant viewers are in other vehicles.

FIG. 7B shows, as an example result of proximity detection, that vehicles 100 and 712, once notified of their proximity to each other, can use their WAN connections to communicate with each other.

FIG. 7C illustrates that two (or more) vehicles, if they are sufficiently close, can connect to each other through their WLANs.

FIGS. 8A and 8B illustrate, respectively, that a rear-mounted telematic unit can capture an image of the license plate of a vehicle behind it and a front-mounted telematic unit can capture an image of the license plate of a vehicle in front of it.

FIG. 8C shows front-mounted frame 130 producing visual information, as represented by light ray 824, traveling to a rear-view mirror 823.

### DETAILED DESCRIPTION OF PREFERRED EMBODIMENTS

Reference will now be made in detail to various embodiments of the invention, examples of which are illustrated in the accompanying drawings. Wherever possible, the same reference numbers will be used throughout the drawings to refer to the same or like parts.

Please refer to the Glossary of Selected Terms, included at the end of the Detailed Description, for the definition of selected terms used below.

Table of Contents to Detailed Description

| 1 | Vehicle Display of Occupant's Message | |
|---|---|---|
| 2 | On-Board Telematics Example Hardware | |
| 3 | Application Development Platform | |
| | 3.1 | Local Usage |
| | 3.2 | Centralized Usage |

| | |
|---|---|
| 3.2.1 | Advertising |
| 3.2.2 | Automated License Plate Reading |
| 3.2.3 | Automated Vehicle Recognition |
| 3.2.4 | License-Plate-Based Addressing |

| | |
|---|---|
| 3.2.4.1 | A Specific Example |
| 3.2.4.2 | Neither Vehicle Needs A Telematic Unit |
| 3.2.4.3 | With Automated License Plate Reading |

| | |
|---|---|
| 3.2.5 | Vehicle Proximity Detection |
| 3.2.6 | Vehicle Location Tracking |
| 3.2.7 | Vehicle Maintenance Tracking |

| | |
|---|---|
| 4 | Glossary of Selected Terms |

### 1 Vehicle Display of Occupant's Message

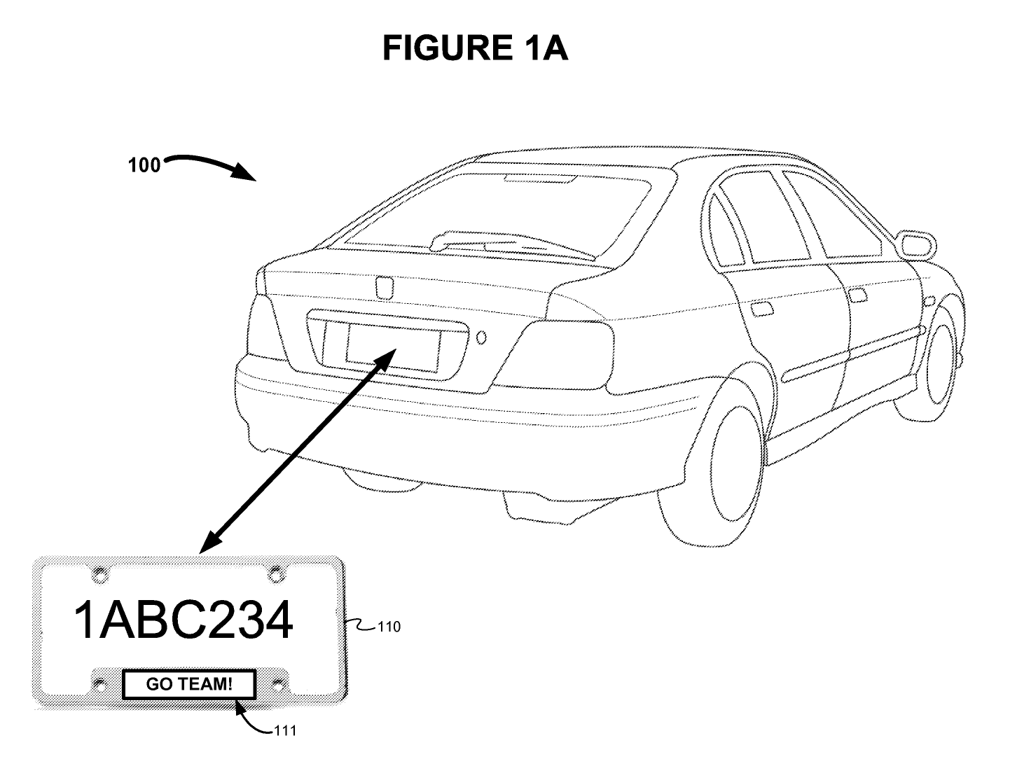

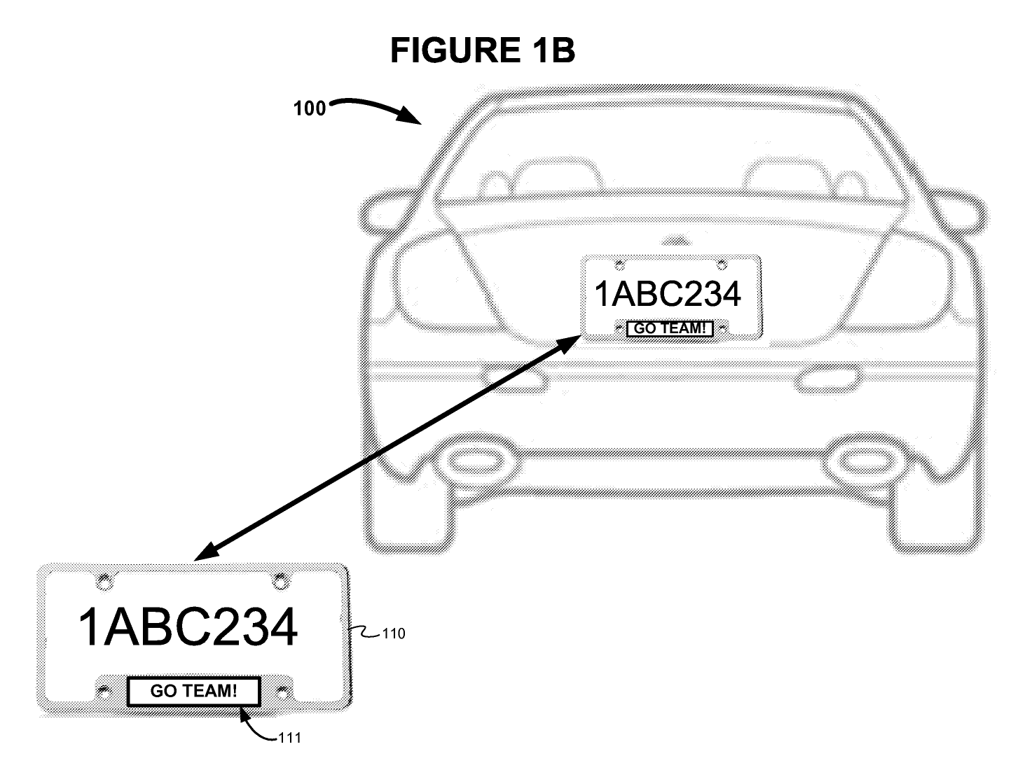

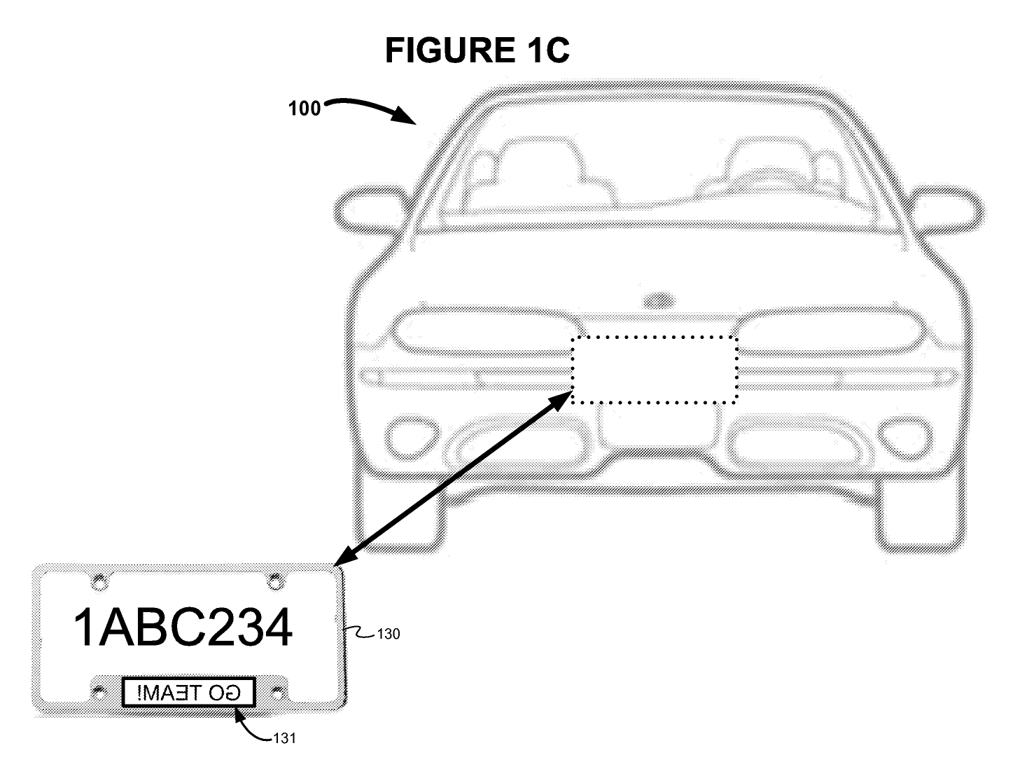

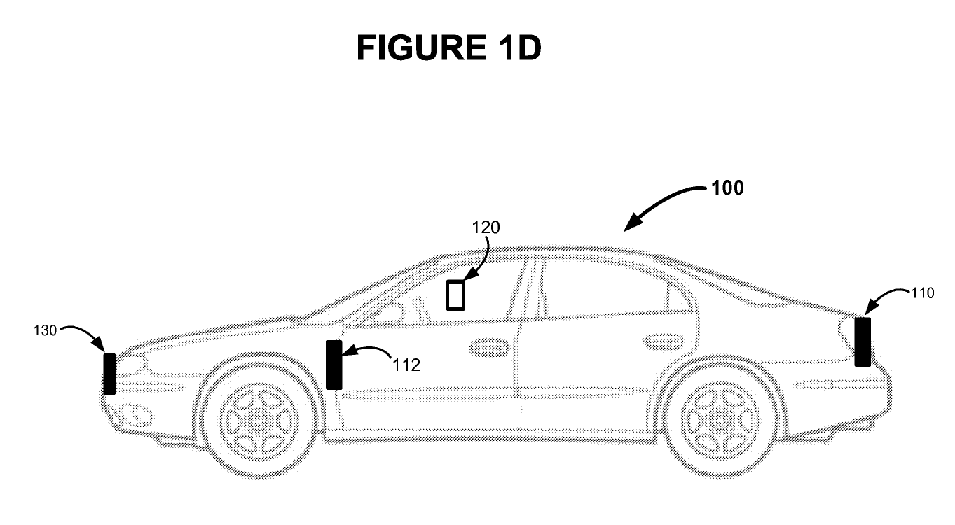

A first embodiment of the present invention permits an occupant of a vehicle, such as vehicle 100 of FIG. 1A, to enter a message with a handheld communications device that has Wide Area Network (WAN) capability (e.g., a Smart Phone, as defined below in the Glossary of Selected Terms) and to have the message externally displayed for reading by persons who are non-occupants of the vehicle. We can refer to the vehicle that displays the message as the “display vehicle.” We can refer to a suitable handheld communications device as a “handheld WAN communications device.” If the handheld WAN communications device can execute application software, we can refer to it herein as a “handheld smart-WAN communications device” (these terms are also defined in the Glossary of Selected Terms).

Non-occupants can include anyone who is in sufficient proximity to the display vehicle. Examples of non-occupants include, but are not limited to:
1. drivers or passengers of other vehicles,
2. pedestrians.

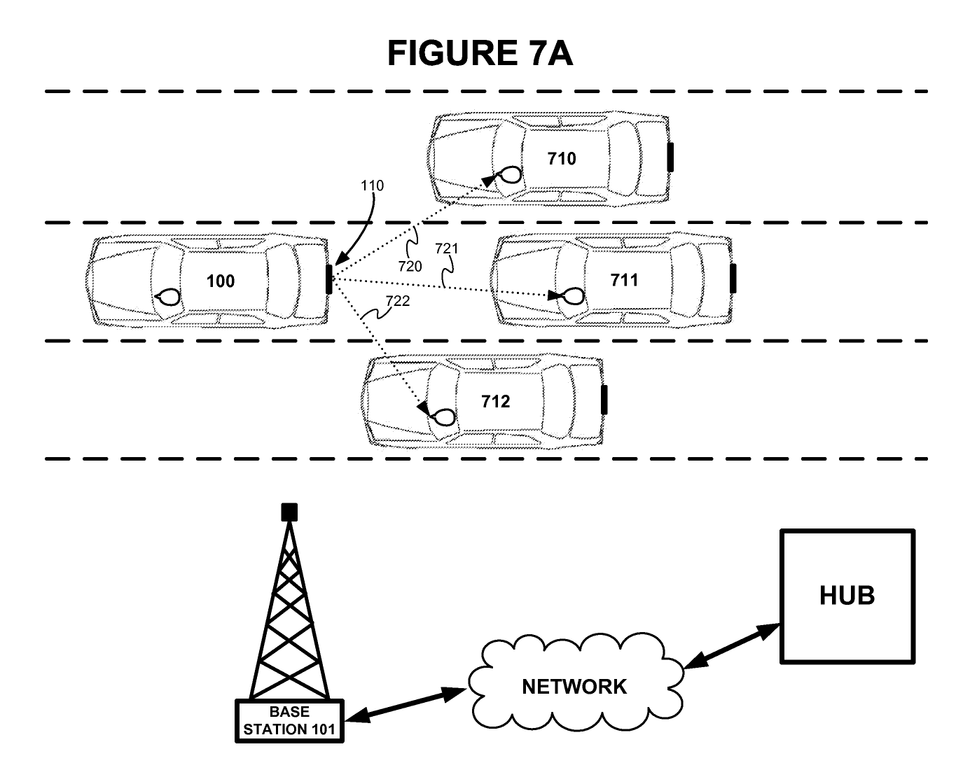

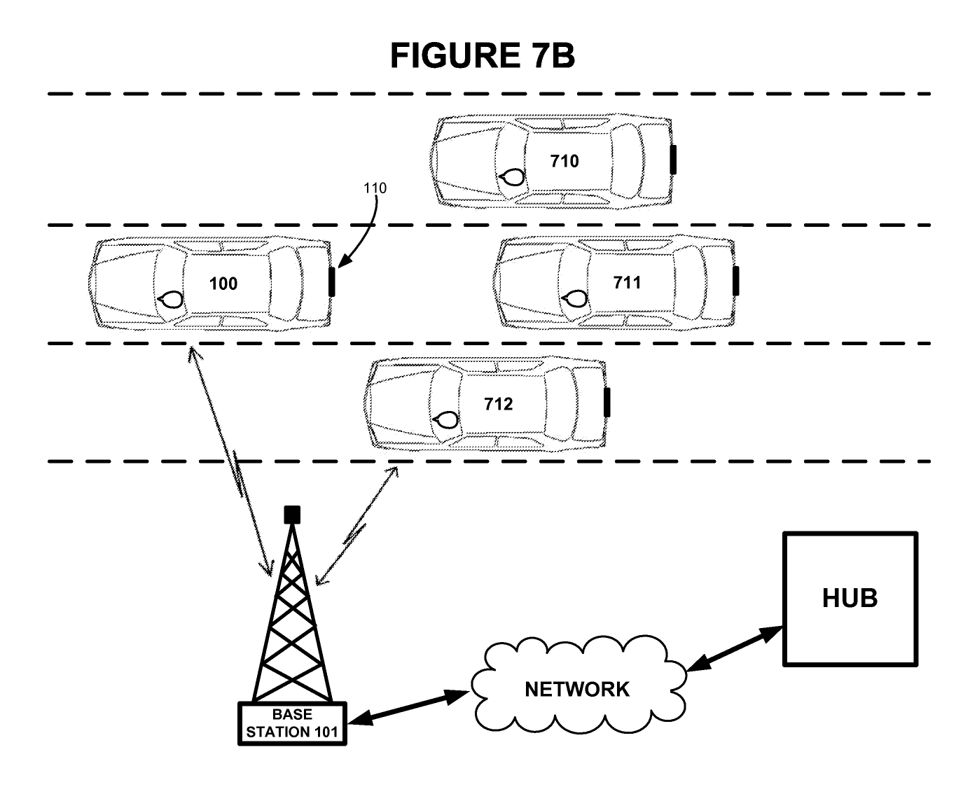

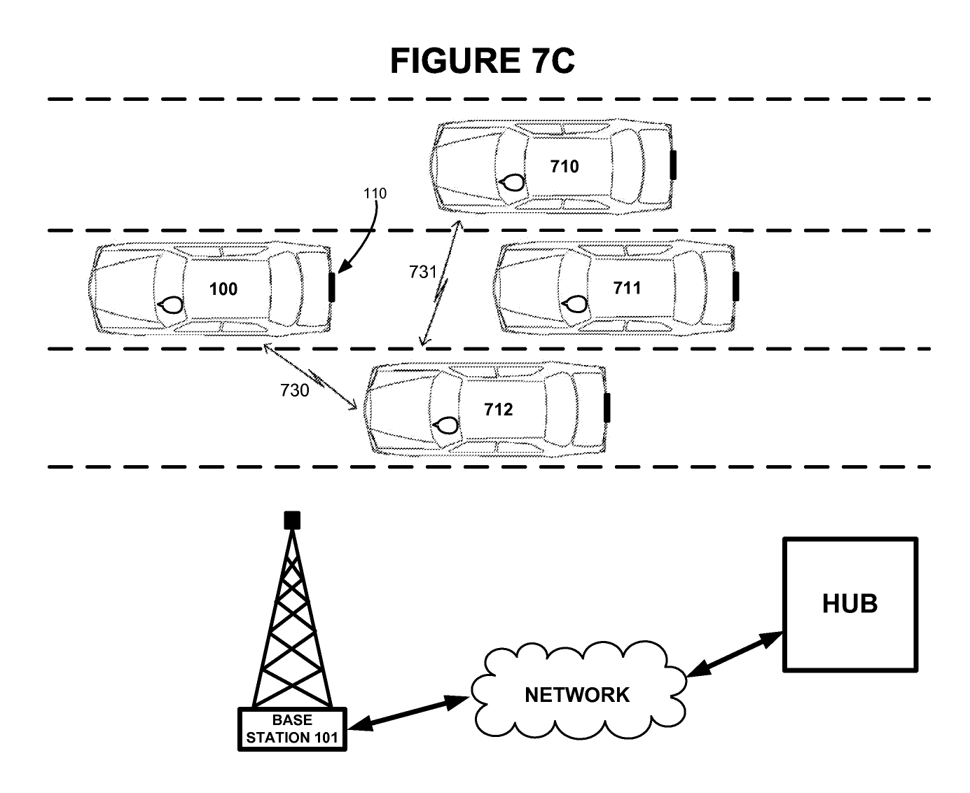

As an example, FIG. 1A shows (in perspective view) a license plate frame 110, mounted on the rear of a vehicle 100, that has been equipped with a display unit 111 (display unit is defined in the Glossary of Selected Terms). FIG. 1B is essentially the same as FIG. 1A, but from a “flat” rear-view perspective. FIG. 7A illustrates the scenario where the non-occupant viewers are in other vehicles. Specifically, vehicle 100, along with vehicles 710-712, are shown on a roadway. Vehicles 710-712 are located behind vehicle 100, and therefore rear-mounted license plate frame 110 is viewable by the drivers of vehicles 710-712. FIG. 7A shows light rays 720-722, radiating from a display unit 111, reaching the drivers of each of, respectively, vehicles 710-712.

FIG. 1D depicts a side view of vehicle 100 that shows, in addition to license plate frame 110, a handheld WAN communications device 120. As an example use scenario, an occupant of vehicle 100 can enter a message, such as “Go Team!,” with handheld WAN communications device 120 and then have such message displayed by display unit 111. (Of course, under an actual use scenario, it would be expected that such message would also include the name of the specific team for whom the occupants of vehicle 100 would like to broadcast their support.)

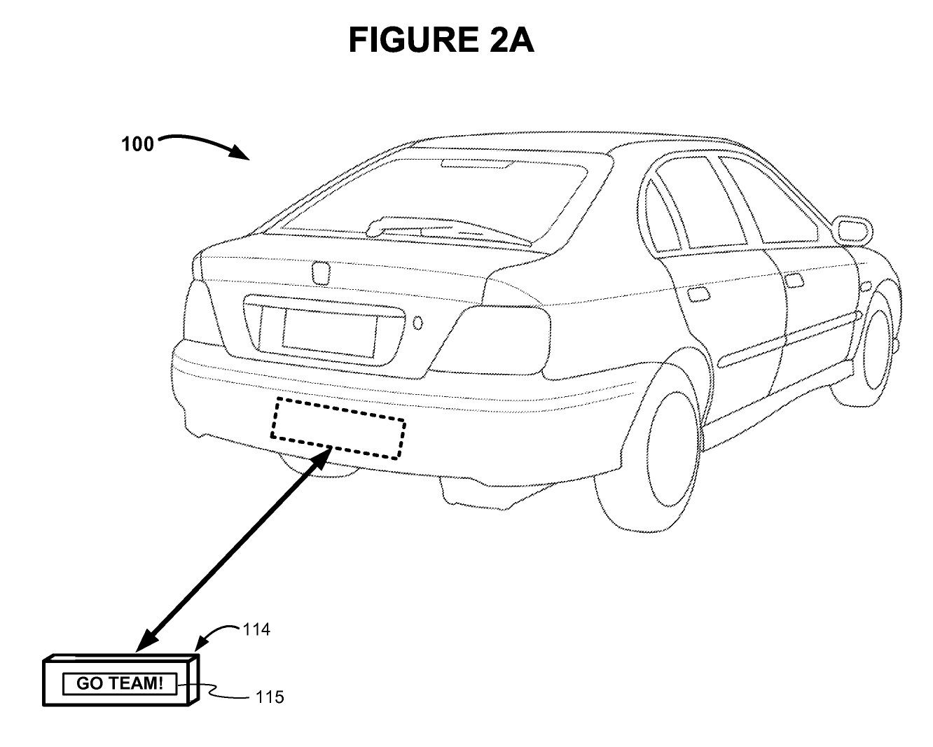

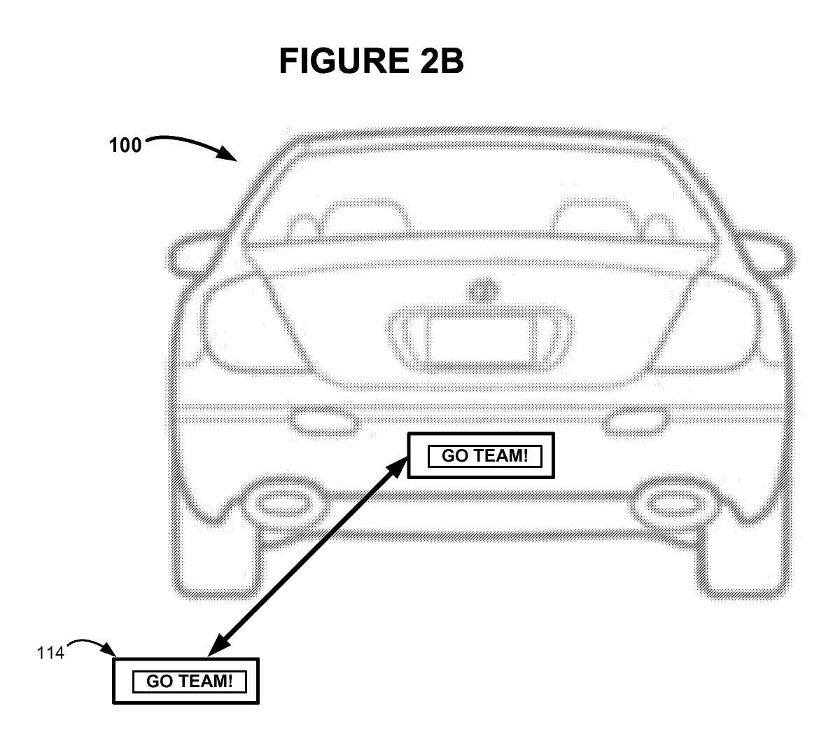

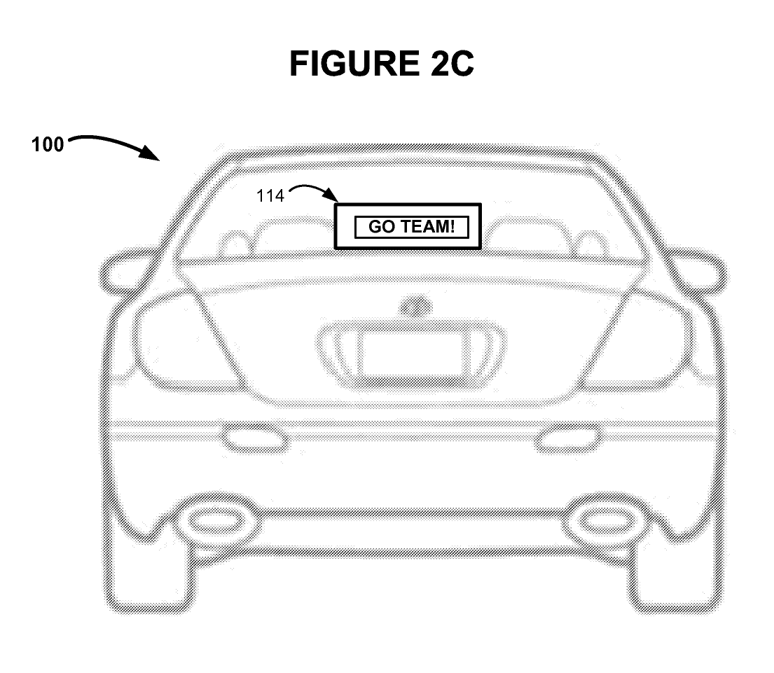

A display unit (or units) for view by non-occupants can be mounted on (or incorporated into) any location of the vehicle that is expected to provide desired viewing opportunities. In general, a particular display unit, along with its supporting electronics and any other materials needed for mechanical support, can be referred to herein as a kind of “telematic unit.” When the display unit is an important component, it can be more specifically referred to as a “telematic display unit.” Purely for purposes of example, and in no way intended to be limiting, some further potential locations for telematic display units include those shown in FIGS. 1C and 2A-2C.

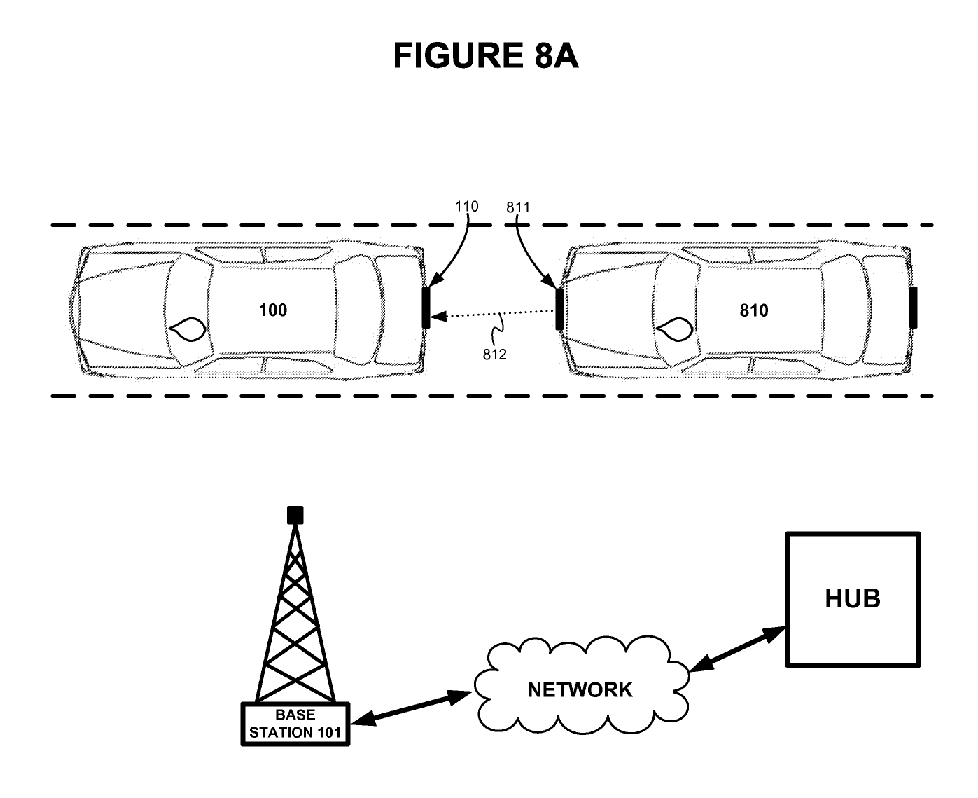

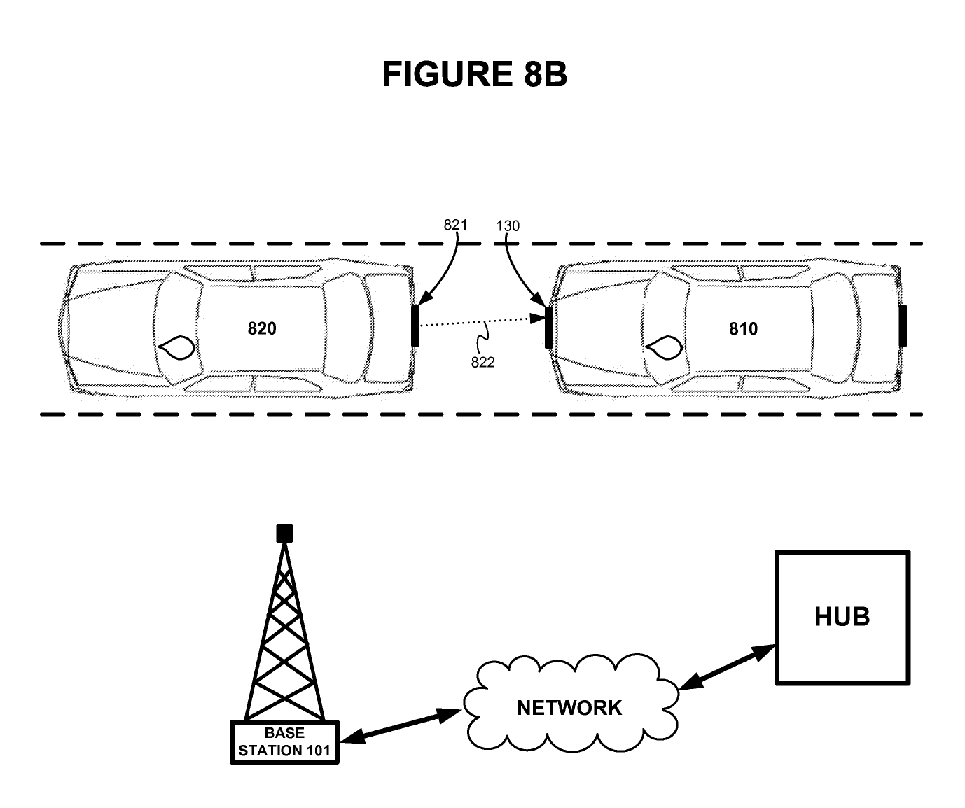

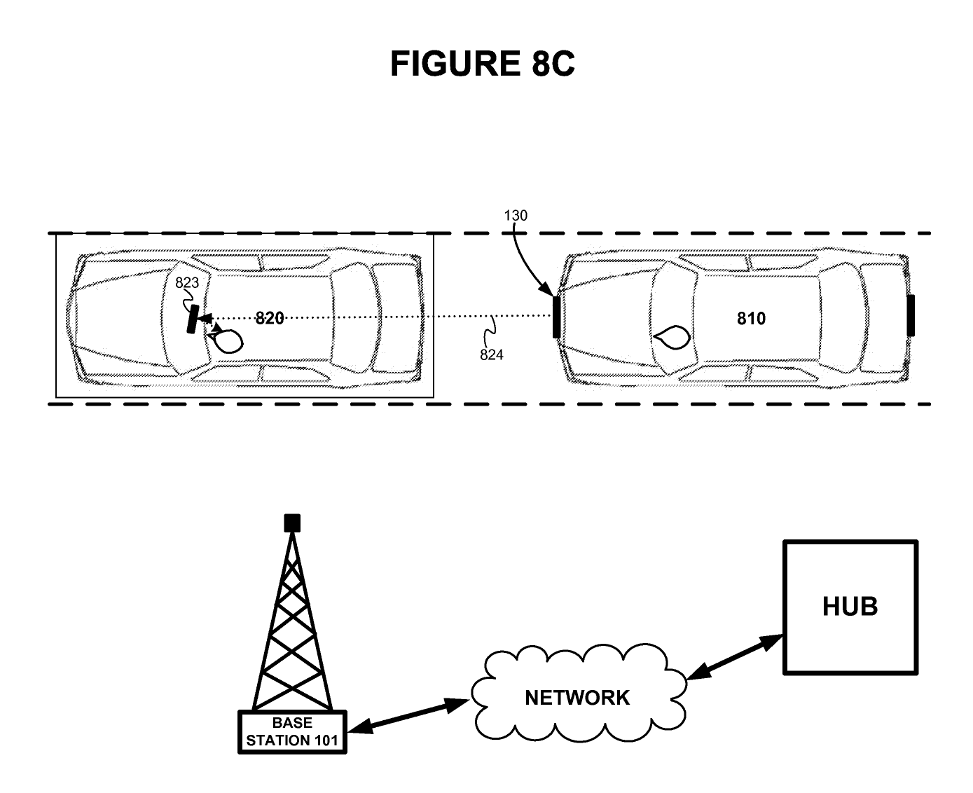

FIG. 1C shows that a front-mounted license plate frame 130 can include a display unit 131. In the case of a front-mounted telematic display unit, since it may be desirable to display a message that can be read in the rear-view mirror of vehicles ahead of vehicle 100, the message can be displayed in an inverted fashion. For example, FIG. 1C shows the same “Go Team!” message of FIGS. 1A-1B, but in an inverted form that can be normally read when viewed as a mirror reflection. Front-mounted frame 130 (like rear-mounted frame 110) is also shown in the side-view of FIG. 1D. FIG. 8C shows front-mounted frame 130 producing visual information, as represented by light ray 824, traveling to a rear-view mirror 823. If the visual information from 130 is inverted, the mirror image, produced by mirror 823, can be read normally by the driver of vehicle 820

FIGS. 2A-2B are essentially the same as, respectively, FIGS. 1A-1B, since they also depict a rear-mounted display device. FIG. 2A-2B differ, however, because telematic display unit 114 (that includes a display unit 115) is mounted on (or incorporated into) the rear-bumper of a vehicle. FIG. 2C is essentially the same as FIG. 2B, except that FIG. 2C shows a telematic display unit 114 that can be viewed through a vehicle's rear window.

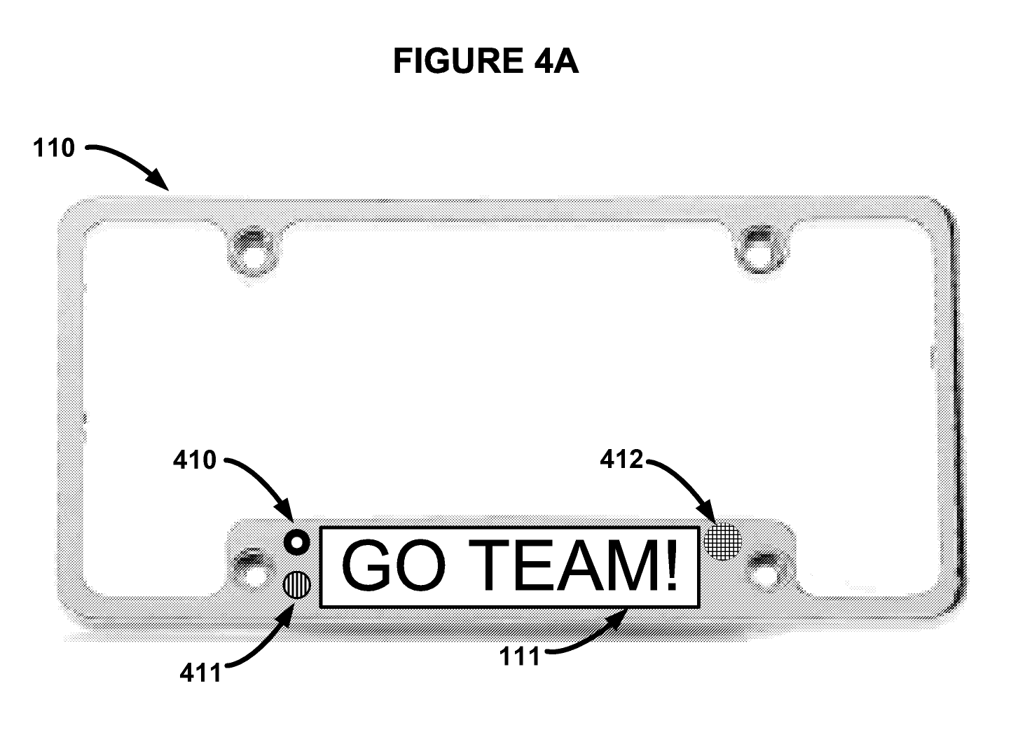

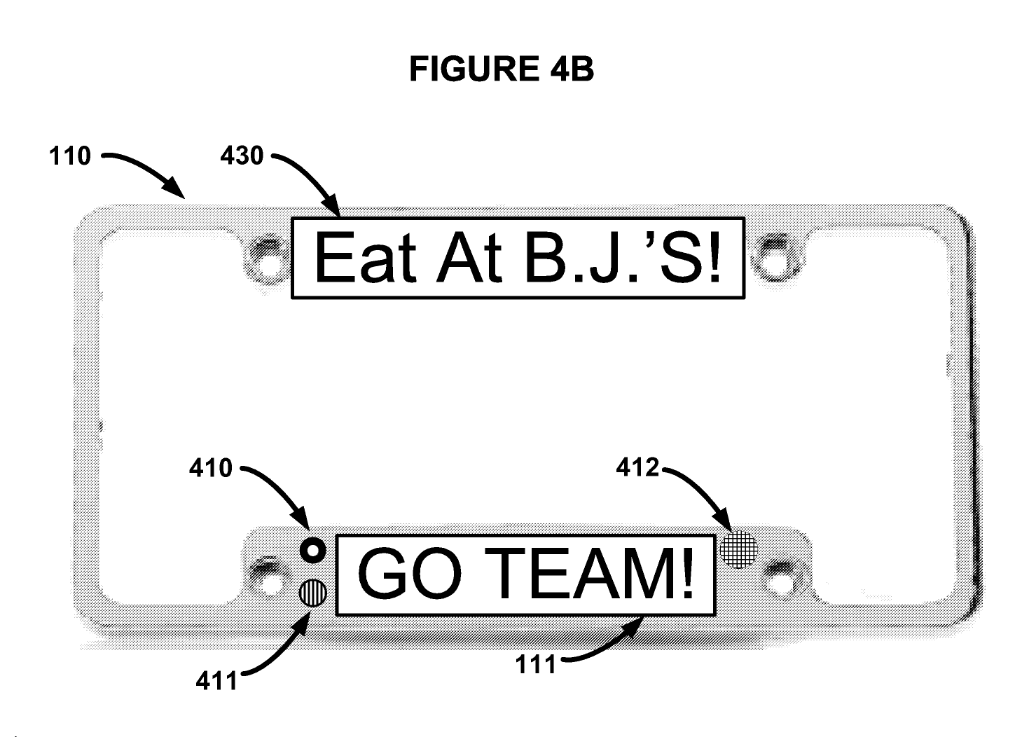

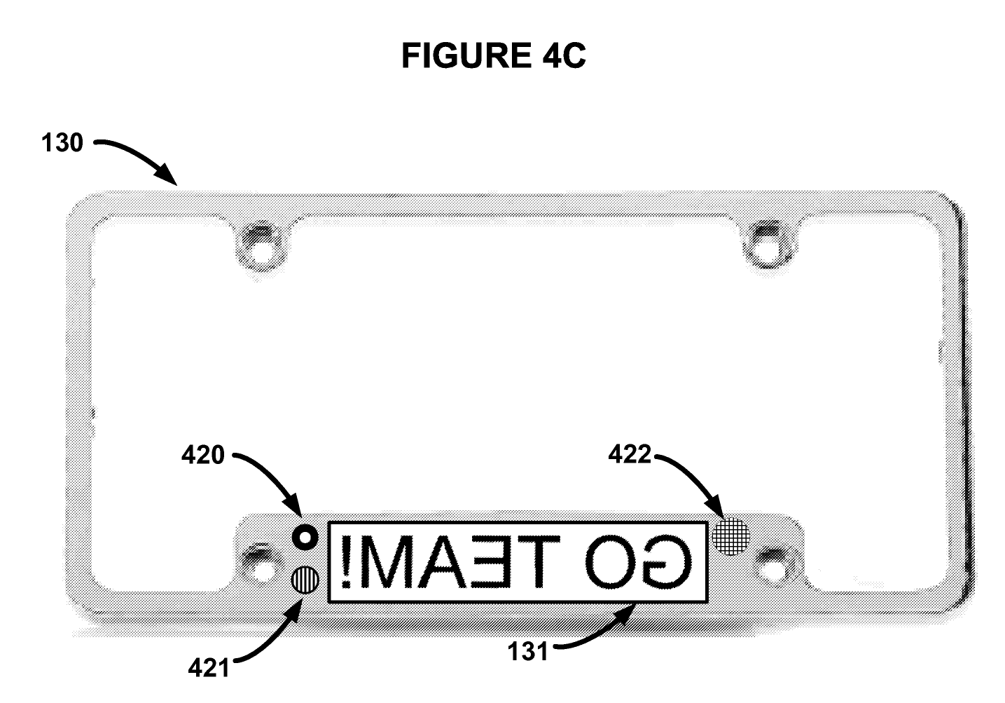

FIGS. 4A and 4C depict, respectively, close-up views of rear-mounted license plate frame 110 and front-mounted license plate frame 130. FIG. 4B shows a version of license plate frame 110 that includes a second display 420. It should be clear, however, that a second display could be added to a front-mounted license plate frame, or to any other telematic display unit. A second display, such as 430, can be dedicated to the showing of paid advertising. The advertising can be distributed to a display unit via a WAN, permitting remote selection and revenue collection, for such advertising, at a centralized data and communications facility. The revenue generated by such advertising can be used to subsidize (or to completely cover) the costs associated with having one or more telematic display units on-board a vehicle. Thus, an owner of a vehicle can incur reduced monetary cost (or perhaps no monetary cost) and still be able to utilize the services provided by having one or more on-board telematic display units.

Rather than incorporating a second display telematic into a telematic display unit, however, there are at least two other possibilities:
1. advertising can also be shown by time-multiplexing use of the display, between messages desired by occupants of the display vehicle and messages that are paid advertisements;
2. the above discussed second display, dedicated to the showing of advertising, can be the only display of a separate telematic display unit.

FIGS. 4A-4C also show that, as an addition (or alternative) to having one or more displays, a telematic unit can incorporate any other suitable kinds of input and/or output devices (also called, respectively, sensors and/or effectors). For example, FIGS. 4A and 4B include:
video and/or still camera 410
microphone 411
speaker 412
   FIG. 4C shows the same input and/or output devices as FIGS. 4A and 4B, except they are indicated by, respectively, the following numbers: camera 420, microphone 421 and speaker 422. Uses for these other kinds of input and/or output devices are addressed in following sections.

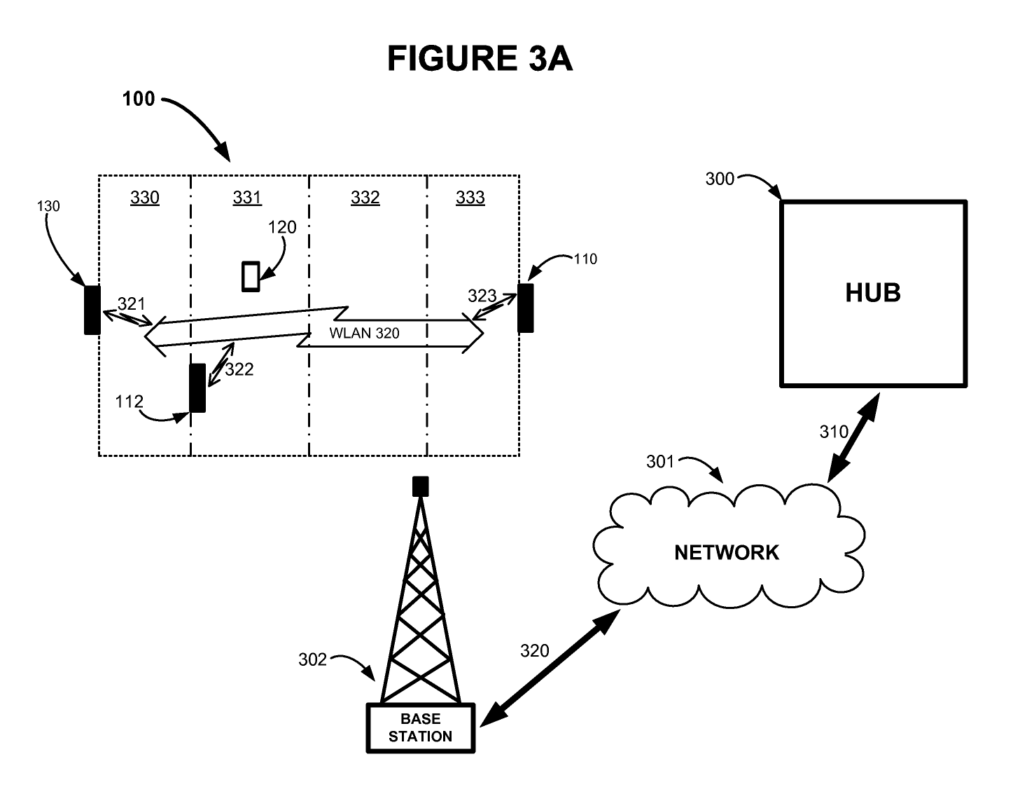

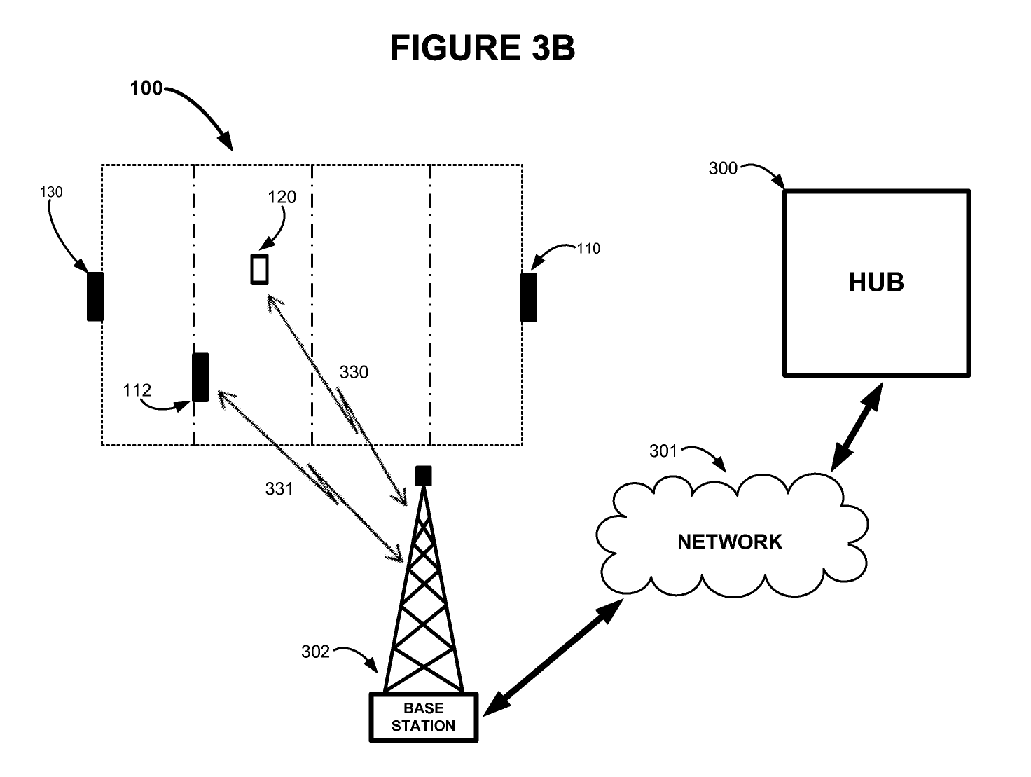

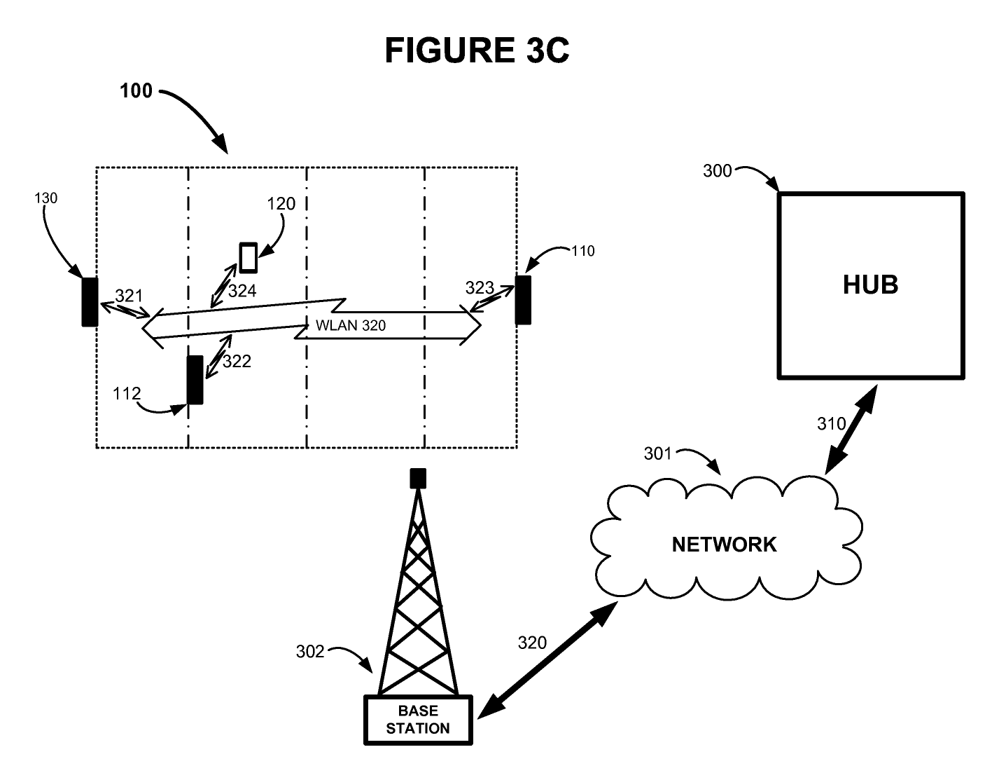

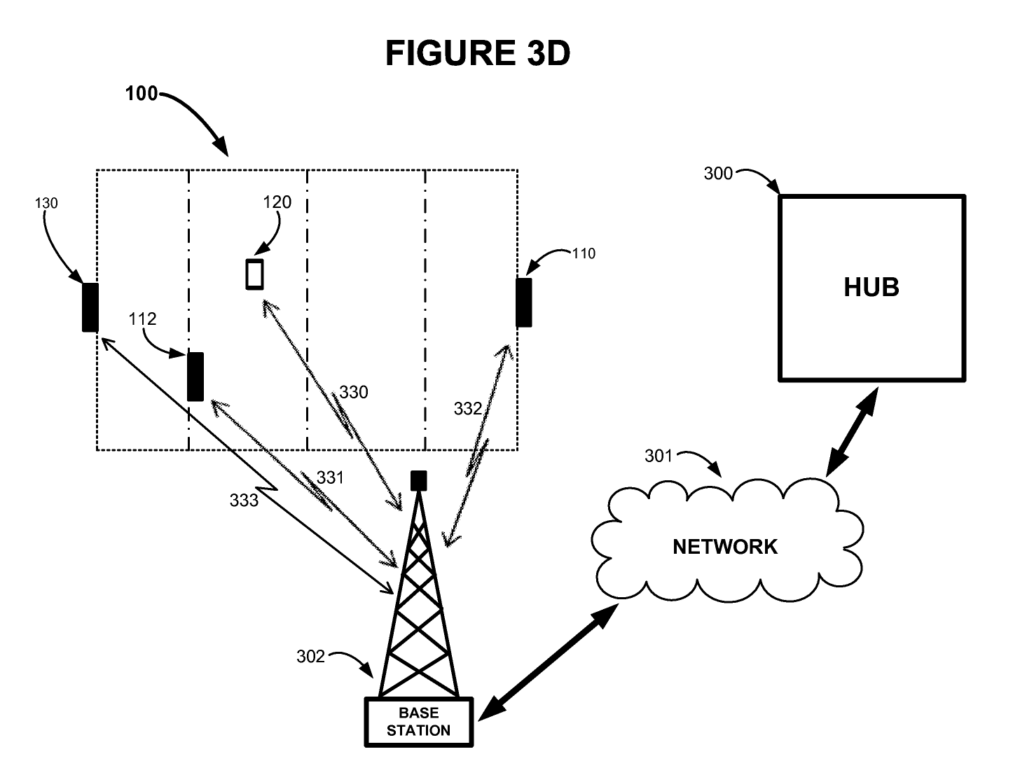

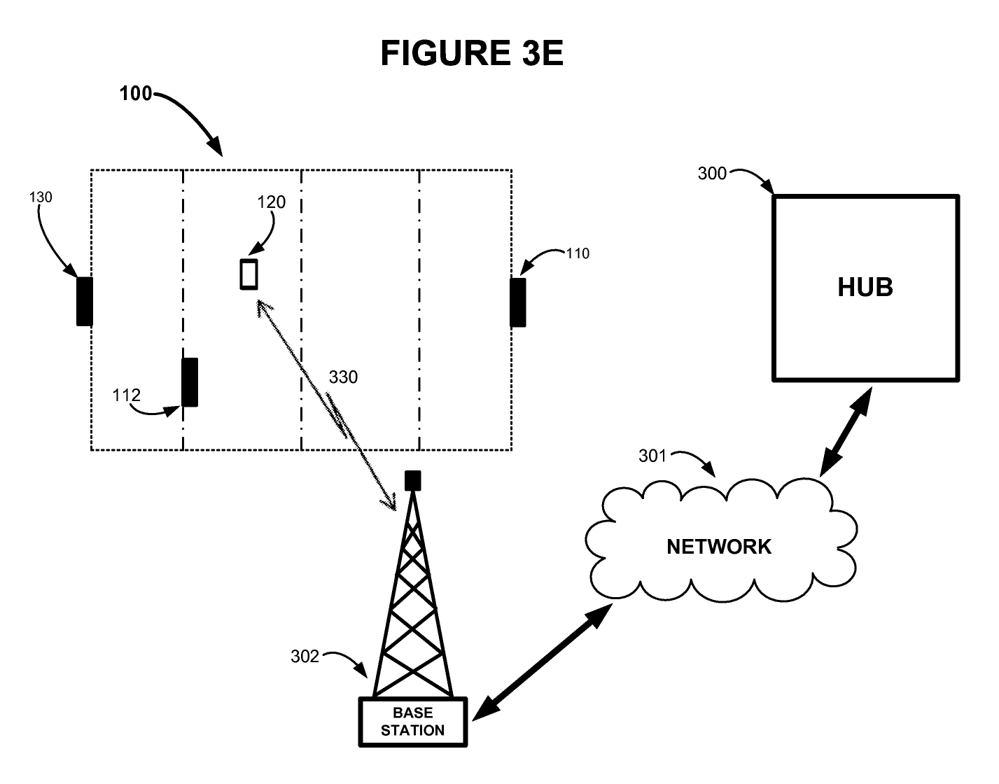

FIGS. 3A-3D depict example configurations by which a message, entered with a handheld WAN communications device, can be transmitted to a display unit. FIGS. 3A-3D share the following feature: representation of vehicle 100 as a dotted outline. A dotted outline is used since the focus of the figures is on using wireless communications. Within dotted outline 100, three vertical lines, each with a same dot-dash pattern, divide the vehicle into four regions. From left to right, these vehicle regions are:
1. front region 330, in which is often located, under a “front hood,” the engine;
2. forward passenger compartment 331;
3. rear passenger compartment 332; and
4. rear region 333, in which is often located “the trunk.”
   While regions 330-333 are present in all of FIGS. 3A-3D, they are only specifically labeled in FIG. 3A.

Within this framework of vehicle regions, the following units are shown:
1. front-mounted telematic display unit 130;
2. rear-mounted telematic display unit 110;
3. gateway and/or systems-monitoring telematic unit 112; and
4. handheld WAN communications device 120.

FIG. 3A shows the following units as connected to each other through a Wireless Local Area Network (WLAN) 320: 130, 110, and 112. It should be noted that since LAN 320 is wireless, “bus” 320 is intended to merely represent a virtual bus, created by action of the connecting units following the applicable protocols. Example WLAN protocols are those for “WiFi,” also known as the 802.11 family of standards. The 802.11 standards are maintained by the Institute of Electrical and Electronics Engineers, a professional organization with a place of business in Washington, D.C., U.S.A. Telematic units 130, 110, and 112 are shown as each having, respectively, the following connections with virtual bus 320: 321, 323, and 322.

When used as a gateway, gateway and/or systems-monitoring telematic unit 112 can provide, for all the on-board telematic units of a vehicle, a centralized connection point with broader networks. For example, FIG. 3B shows unit 112 as providing a connection 331 to a WAN, such as a cellular telephone network 301 (the cellular network reached, in FIGS. 3A-3D, through an example antenna and base station 302). FIG. 3B also shows handheld WAN communications device 120 as having a WAN connection 330 to cellular telephone network 301. (While FIG. 3B shows 112 and 120 connecting to a same WAN, in general this need not be the case and each device can connect to its own WAN.)

An occupant of vehicle 100, who has entered a message on communications device 120, can therefore have the message traverse the following path in order to reach that vehicle's telematic display units:
1. communications device 120 to WAN (e.g., WAN 301) via connection 330;
2. WAN (e.g., WAN 301) to gateway 112 via connection 331; and
3. gateway 112 to telematic display units 110 and/or 130, via WLAN 320.

Additionally, in-between steps 1 and 2 of the above-listed path traversal, the message can travel through a data and communication center 300 (called a “hub” in FIGS. 3A-3D). Hub 300 is discussed further in following sections.

As an addition, or alternative, to acting as a gateway, telematic unit 112 can provide systems-monitoring of vehicle 100. For example, On-Board Data II (also known as OBD-II or OBD2) is an SAE standard by which data interchange, with a vehicle's on-board computers, is made available for use by equipment not necessarily produced by the vehicle's manufacturer. Please see the below Glossary of Selected Terms for further description of OBD-II/OBD2.

An OBD-II connector is required to be within two feet of the steering wheel and accessible from the passenger compartment. The placement of telematic unit 112, in FIGS. 3A-3D, is intended to be generally in accordance with OBD-II accessibility. Use of telematic unit 112, and the kind of data it can collect through an OBD-II connection, is discussed further in following sections.

As an alternative to the communication paths depicted by FIGS. 3A-3B, FIG. 3C depicts a configuration in which the handheld WAN communications device 120 (and not just the on-board telematic devices) is also connected to WLAN 320. Handheld WAN communications device 120 connects to WLAN 320 through connection 324. In this configuration, a message, entered on communications device 120 by an occupant of vehicle 100, need only traverse the WLAN in order to reach the vehicle's telematic display units.

FIG. 3D depicts the fact that there is no need for the use of a LAN, to achieve communication between handheld WAN communications device 120 and any of the on-board telematic units. This is because each telematic unit is shown as (possibly) having its own WAN connection. In particular, front-mounted display unit 130 can have its own WAN connection 333 and rear-mounted display unit 110 can have its own WAN connection 332.

It should be noted that the occupant of vehicle 100 can enter the message for display using any suitable user interface of handheld WAN communications device 120. Some examples include an alphanumeric keyboard, speech-to-text conversion, and gesture recognition.

In another embodiment of the invention, the device, into which the occupant enters the message for display, need not be handheld with WAN capability, but the entry device's user interface is based on speech-to-text conversion and/or gesture recognition. This embodiment can be useful, for example, where the original manufacturer of the vehicle adds an interface whereby messages for display can be entered.

### 2 On-Board Telematics Example Hardware

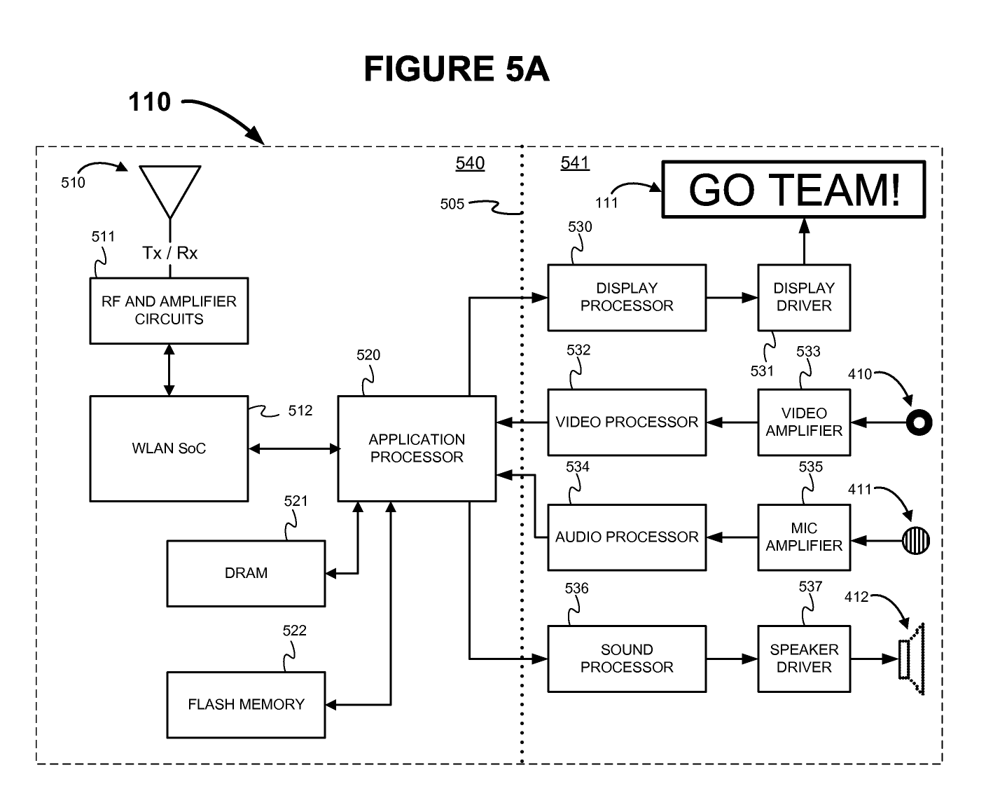

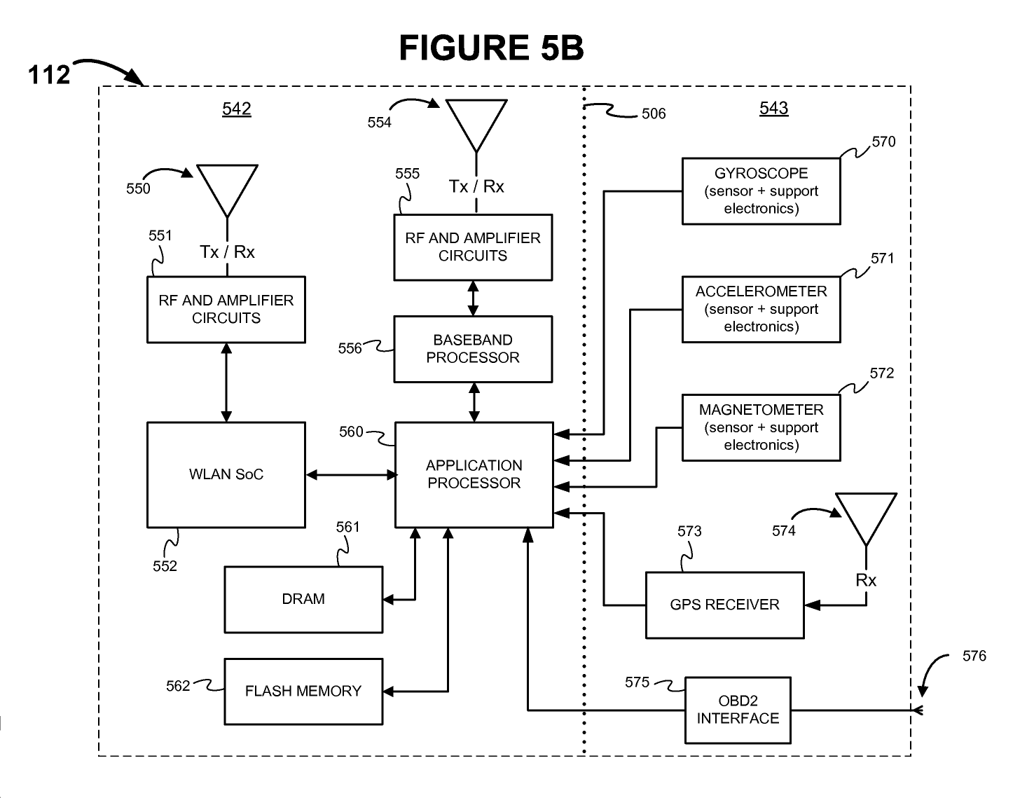

Regarding the potential on-board telematic units discussed thus far, FIGS. 5A-5B present example hardware implementations. Specifically, FIG. 5A depicts an example implementation of a rear-mounted telematic unit 110. The same implementation of FIG. 5A can also be applied to a front-mounted telematic unit 130. FIG. 5B depicts an example implementation of gateway and/or systems-monitoring telematic unit 112. Each of these diagrams will now be addressed in more detail.

Vertical dotted line 505 divides the hardware of FIG. 5A (where such hardware is typically implemented with electronic and integrated circuit technologies) into two main regions:
1. Region 540: contains a general purpose Application Processor 520 (e.g., a low-power microprocessor, manufactured by ARM Holdings plc, a company with a place of business in Cambridge, United Kingdom) and wireless networking hardware. In the particular case of FIG. 5A, the only wireless networking capability shown is that of a WLAN System-on-Chip 512 with RF circuits 511 and antenna 510. In general, however, region 540 can contain any appropriate wireless networking capabilities, such as WAN capability.
2. Region 541: contains any appropriate input and/or output devices, along with any necessary supporting hardware. For an output device, supporting hardware can include driver circuitry and, prior to such drivers, any necessary application-specific processing capability. Conversely, for an input device, supporting hardware can include amplifier circuitry and, following such amplifiers, any necessary application-specific processing capability.
   In particular, the following example output devices are shown for region 541:
1. a display unit, such as display unit 111 of rear-mounted telematic unit 110, driven by driver circuits 531 and display processor 530. Display 111 can be of any suitable configuration or type (please see below Glossary of Selected Terms, for further discussion of the term “display unit” as used herein). While only a single display is shown in FIG. 5A, it should be understood that multiple displays could be incorporated into a single telematic unit (such as the telematic unit of FIG. 4B, that shows a second display 430). Each display can be driven by a driver/display-processor combination similar to that shown in FIG. 5A.
2. a speaker 412 (or any other suitable sound-producing device), driven by driver circuits 537 and sound processor 536.
   The following example input devices are shown for region 541:
1. still and/or video camera 410, that produces signals amplified by 533 and processed by video processor 532.
2. microphone 411 (or any other suitable audio input device), that produces signals amplified by 535 and processed by audio processor 534.

Similarly to FIG. 5A, vertical dotted line 506 divides the hardware of FIG. 5B (where such hardware is typically implemented with electronic and integrated circuit technologies) into two main regions:
1. Region 542: contains a general purpose Application Processor 560 (e.g., a low-power ARM microprocessor) and wireless networking hardware. Two types of wireless networking capability are shown:
   WLAN: implemented with System-on-Chip 552, RF circuits 551, and antenna 550.
   WAN: implemented with Baseband Processor 556, RF circuits 555, and antenna 554.
2. Region 543: contains any appropriate input and/or output devices, along with any necessary supporting hardware. For an output device, supporting hardware can include driver circuitry and, prior to such drivers, any necessary application-specific processing capability. Conversely, for an input device, supporting hardware can include amplifier circuitry and, following such amplifiers, any necessary application-specific processing capability.

The following example input/output device is shown for region 543: OBD2 interface 575, that couples with a vehicle's on-board computer systems via connector 576 (please see below Glossary of Selected Terms for further description of OBD2).

The following example input devices are shown for region 543:
1. gyroscopes 570;
2. accelerometers 571;
3. magnetometer 572; and
4. Global Positioning System (GPS) receiver 573, receiving GPS signals via antenna 574.

In general, as discussed in the previous section with respect to FIGS. 3A-3E, FIGS. 5A and 5B are only examples of the kinds of telematic hardware that can be placed on a vehicle and of the potential partitioning of such hardware among separate telematic units.

In one embodiment of the present invention, the hardware and/or software of such telematic units can be made “open.” In this context “open” refers to the ability of multiple, independent, businesses to produce such devices and/or software. Further, the businesses that produce such telematic hardware and software can be independent of any business that operates a “hub” (or centralized data and communication center). The hub, discussed further below (Section 3 “Application Development Platform”), provides a centralized location with which the telematic units, operating on a large number of vehicles, can interchange data. Even with open production of telematic hardware and/or software, in some embodiments of the invention, certain hardware and/or software can be produced by the hub's operating company.

Open production of telematic hardware and/or software can encourage both a larger number of companies to undertake production and greater innovation in the products developed.

### 3 Application Development Platform

The kinds of sensors and effectors described in previous sections (that are part of vehicle-mounted telematic units) can be utilized locally, within the vehicle to which they are attached, by application software (individually referred to herein as an “Application” or “App”) running on an on-board telematic unit and/or an occupant's handheld smart-WAN communications device. Alternatively (or additionally), through a WAN connection, sensors and effectors can interchange data with a remote location that provides a centralized platform for data processing (also referred to herein as a “data and communication center” or “hub”). Some examples of local usage are presented in the following subsection (3.1 “Local Usage”), with the next subsection (3.2 “Centralized Usage”) addressing the use of a centralized hub. However, it should be understood that any of the Apps discussed in this section can operate on a local processing platform, a centralized processing platform, or a combination of the two.

3.1 Local Usage

If a vehicle is equipped with a rear video camera, such as camera 410 (of FIG. 5A) for rear-mounted telematic unit 110, a WLAN within the vehicle can be used to transmit the video feed to the driver's handheld smart-WAN communications device. Thus, a “live” video image, as seen from the rear of the vehicle, can be displayed on the driver's handheld device and used for such purposes as vehicle parking. If the rear-mounted telematic unit is sold as an after-market accessory, and if the vehicle on which it is installed was not manufactured with a rear-mounted video camera, then the present invention makes possible a new after-market capability for such vehicles, that can be seen as highly desirable by many drivers.

If a vehicle is equipped with a sound producing device, such as speaker 412 (of FIG. 5A) for rear-mounted telematic unit 110, a WLAN within the vehicle can be used to achieve the following kinds of functionality, in connection with use of an occupant's handheld smart-WAN communications device:
An audio message, that an occupant desires broadcast from the rear of the car, can be spoken into the occupant's handheld smart-WAN communications device. Such audio message can be transmitted (over the WLAN) to the rear-mounted telematic unit 110 that then plays the transmitted audio.
A vehicle's owner may desire the production of a warning sound, to inform pedestrians of the vehicle being in proximity to them. Any type of audio signal can be broadcast by the vehicle, as long as it is suitable for use as a warning sound. For the example of rear-mounted telematic unit 110, the warning sound can be stored on the telematic unit, with the occupant's handheld smart-WAN communications device simply serving to start or stop production of the warning sound. Alternatively, the warning sound can be transmitted (over the WLAN) to the rear-mounted telematic unit 110 that then plays the transmitted audio.

FIGS. 3A and 3C are discussed above (Section 1 “Vehicle Display of Occupant's Message”) as presenting a WLAN for use within a single vehicle 100. However, if two (or more) vehicles are sufficiently close, such as is illustrated in FIG. 7C, they can connect to each other through their WLANs. For example, FIG. 7C shows an RF signal 730, that spans and connects vehicle 100 with vehicle 712. A similar connection is shown, between vehicles 712 and 710, by RF signal 731. Detection, of whether vehicles are sufficiently close to share a WLAN, can be accomplished by any suitable technique. Below is discussed an example (Section 3.2.5 “Vehicle Proximity Detection”) of how such vehicle proximity detection can be accomplished with a hub.

3.2 Centralized Usage

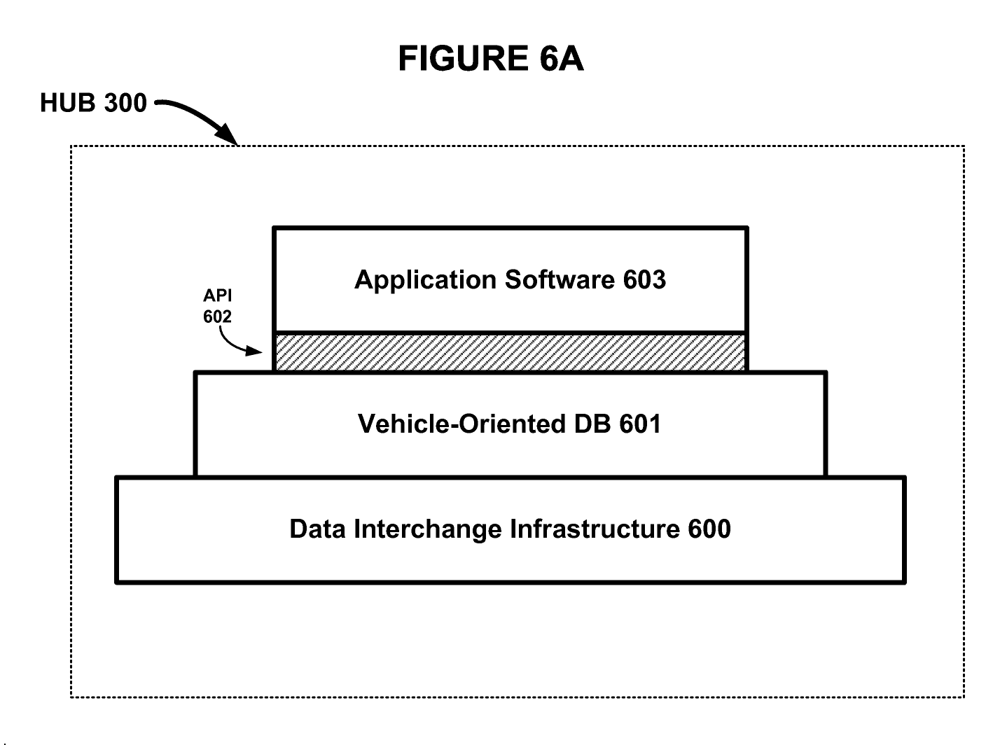

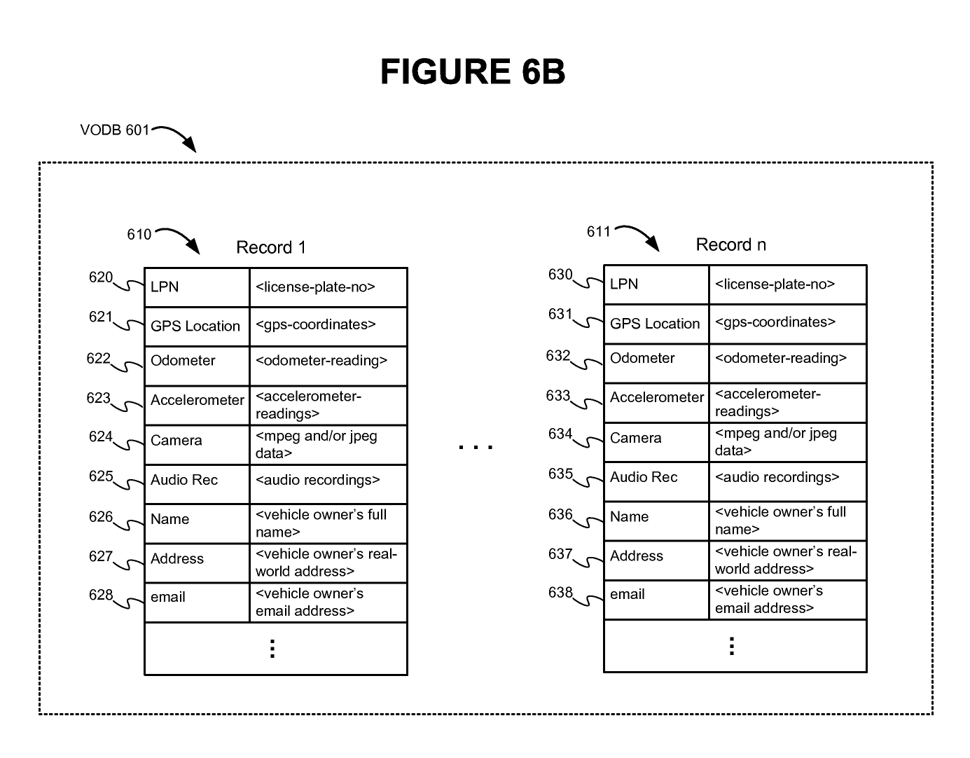

The sensors and effectors (or input and output devices) of vehicle-mounted telematic units can interchange data, through a WAN connection, with a remote centralized data and communication center or “hub.” An example basic structure, for this kind of hub, is shown in FIG. 6A.

As can be seen, the lowest-level tier, of hub 300, is its Data Interchange Infrastructure 600 (please see Glossary of Selected Terms for a definition of “interchange”). For sensory data, from the vehicle-mounted telematic units, Infrastructure 600 provides hardware and software for collecting such data. Once collected, that data can be used to update a Vehicle-Oriented DB 601. In one mode of the present invention, Vehicle-Oriented DB 601 is updated approximately continuously with the vehicle's sensory data. Through an Application Programming Interface (API) 602, Vehicle-Oriented DB 601 is made available to Application Software (or “Apps”) 603. In one embodiment of the present invention, the API can be made “open.” In this context “open” refers to the ability of multiple, independent, businesses to produce Apps that utilize the API. Further, the businesses that produce Apps can be independent of any business that operates the “hub.” In some embodiments of the invention, a business that produces hardware and/or software for on-board telematic units (such as discussed above in Section 2 “On-Board Telematics Example Hardware”) can be the same as a business that produces one or more Apps. Even with an open API, in some embodiments of the invention, certain Apps can be produced by the hub's operating company.

An open API can encourage both a larger number of companies to develop application software and greater innovation for the Apps developed.

Database 601 is referred to as “vehicle-oriented” because it is expected to have at least some records where a vehicle identifier serves as a primary key. An example of such vehicle orientation is illustrated in FIG. 6B. If hub 300 is, at a particular point in time, interchanging data with a population of n different vehicles, it can be expected to have at least n vehicle-oriented records. In FIG. 6B, only the 1^{st} and n^{th} records are depicted. The 1^{st} and n^{th} records are indicated as, respectively, records 610 and 611. As can be seen, each record has a field (620 for record 1 and 630 for record n) containing the license plate number of the vehicle it represents. Assuming each vehicle's license plate number is unique, this field can be used as a primary key for accessing the database. As will be discussed further below, it may be necessary to apply certain additional information to a license plate number, according to certain procedures, in order to produce a truly vehicle-unique value.

For purposes of example, each record of Vehicle-Oriented DB 601 is shown as having the following 8 additional fields (where the following fields are described as being for an arbitrary vehicle “X,” selected from the range 1 to n):
1. GPS Location: updated to contain the current GPS coordinates for vehicle X. An example GPS unit, that could provide such data, is GPS unit 573 of FIG. 5B.
2. Odometer: updated with vehicle X's odometer reading. Odometer information may be originally collected by a vehicle's on-board computers, as provided by the vehicle's manufacturer. In this case, an example access point, for obtaining such information, is ODB2 Interface 575 and its connector 576.
3. Accelerometer: updated with the current accelerations being undergone by vehicle X. An example acceleration-sensing unit, that could provide such data, is Accelerometer unit 571 of FIG. 5B.
4. Camera: updated to contain still photos, and/or video, as collected by an on-board camera (or cameras) of vehicle X. An example camera sensor is indicated by numeral 410 in FIG. 5A.
5. Audio Recording: updated to contain audio information, as collected by an on-board microphone of vehicle X. An example audio sensor is indicated by numeral 411 in FIG. 5A.
6. Name: Name of a person “P” who wants to be identified as an occupant (driver and/or passenger) of vehicle X.
7. Address: real-world address of person P.
8. Email: an email address “E” at which person P can be contacted.

Of course, the above-listed fields are shown only for purposes of example. Any suitable selection of the above fields, and/or any suitable selection of additional fields, can be utilized.

Any suitable WAN connection or connections can be used to provide a path for data interchange, between a vehicle's telematic units and its hub 300. As was discussed above with respect to FIG. 3B (Section 1 “Vehicle Display of Occupant's Message”), only one of the telematic units may have the WAN connection (unit 112), and this telematic unit can act as a gateway to the WAN for the vehicle's other telematic units. (As was discussed above in Section 1 with respect to FIG. 3A, the other telematic units can get to the gateway through an on-vehicle WLAN.) Alternatively, as was discussed above with respect to FIG. 3D (also in Section 1), each telematic unit can have its own WAN connection. A third possibility, not discussed above, is for the vehicle's telematic units to use, as their gateway, the WAN connection of an occupant's handheld WAN communications device. Under this third scenario, the telematic units interchange data with the handheld WAN communications device through an on-vehicle WLAN (as shown in FIG. 3C). The handheld WAN communications device then interchanges such data, through its WAN connection, with hub 300. FIG. 3E is the same the FIG. 3D of Section 1, except that FIG. 3E shows a single WAN connection, provided by handheld WAN communications device 120, as shared by both the handheld WAN communications device and the vehicle's telematic units.

Vehicle-Oriented DB 601, when updated by information interchange as described above (in this Section 3.2), and combined with an API 602, provides a basis for a wide array of Apps (for application software layer 603). Some example Apps follow.

3.2.1 Advertising

As discussed above with respect to FIGS. 4A-4C (Section 1 “Vehicle Display of Occupant's Message”), display units can be used to show advertising. As was also discussed above, such advertising can be shown on a display dedicated to the showing of advertising, or a single display can time multiplex between showing occupant messages and advertising.

Hub 300, in conjunction with Vehicle-Oriented DB 601, can be used as an effective platform for the distribution of such advertising. For example, an advertisement distribution App can be added to application software layer 603. The advertisement distribution App can have its own advertisement database, containing a separate record for each advertisement a third party has contracted for display among the population of vehicles. Along with storing the advertisement itself, the advertisement database can store various demographics and/or characteristics, that select a subset, of the vehicle population, on which the advertisement is actually shown.

The subset can be identified by searching for such demographics and/or characteristics among the records of a Vehicle-Oriented DB (such as Vehicle-Oriented DB 601). Once a record (which we shall call “R1”) of the Vehicle-Oriented DB has been identified, as corresponding to a vehicle (which we shall call “V1”) that is to have a particular advertisement displayed, actual display of the advertisement can be accomplished by having the advertisement distribution App write the advertisement to an appropriate “push” field of R1. Data Interchange Infrastructure 600 will then push such advertisement onto the appropriate display of V1, as part of Infrastructure 600's general maintenance of approximately continuous data interchange between the vehicle population and the records of the Vehicle-Oriented DB.

3.2.2 Automated License Plate Reading

As illustrated by FIGS. 8A and 8B, respectively, a rear-mounted telematic unit can capture an image of the license plate of a vehicle behind it and a front-mounted telematic unit can capture an image of the license plate of a vehicle in front of it. Specifically, FIG. 8A shows light rays 812, from a front-mounted license plate 811 of a vehicle 810, being captured by a camera, on a vehicle 100, that is part of rear-mounted telematic unit 110. Conversely, FIG. 8B shows light rays 822, from a rear-mounted license plate 821 of a vehicle 820, being captured by a camera, on a vehicle 810, that is part of front-mounted telematic unit 130.

Once a license plate image is captured, its information can be extracted by the application of any suitable automated techniques. For example, textual information can be extracted by Optical Character Recognition (or “OCR”) software. Such textual information can include the license plate number and the issuing-state of the license.

In general, if license plate textual information is captured by the camera of a vehicle “X,” such textual information can be added to an appropriate field of a record, such as a record “Rx” of the Vehicle-Oriented DB, that represents vehicle X. Any appropriate App, that is part of application software layer 603, can then utilize such license plate textual information.

An example App is for Child Abduction Emergency bulletins (also known as “AMBER Alerts”) as issued by appropriate law-enforcement agencies of the U.S. An AMBER Alert usually contains at least the following information (if available):
name and description of the child abducted,
description of the suspected abductor, and
license plate number of the abductor's vehicle.

An App (also referred to herein as an “AMBER Alerts App”), running at hub 300, can receive such AMBER Alerts and, for each vehicle X that has chosen to participate, seek to automatically match the license plate number of an abductor's vehicle with the license plate textual information of the record R. If a match is found, the App can automatically initiate any and all appropriate actions, including the following:
Alert the occupants of vehicle X, possibly through a handheld WAN communications device 120 (such as shown in FIG. 1D), that the vehicle of an alleged abductor is in proximity to vehicle X;
Alert the appropriate law-enforcement agency. If the telematic equipment of vehicle X includes GPS, the alert sent to law-enforcement can include the GPS location where the match occurred.

The image processing (including OCR) of a license plate image can be performed by any suitable software and/or hardware, and at any suitable point, in the above-described process. For example, if the image to be processed is stored in the Vehicle-Oriented DB (for example, in a field of Rx), the AMBER Alerts App itself can do the image processing. Alternatively, if the image processing is performed along the path of data flow from vehicle X's camera to vehicle X's record Rx, two possible locations are as follows:
1. an application processor of an on-board telematic unit;
2. Data Interchange Infrastructure 600.

3.2.3 Automated Vehicle Recognition

In a manner similar to that described above, for “Automated License Plate Reading,” images other than that of a license plate can be captured by the digital camera of an on-board telematic unit. For example, depending upon whether a camera is rear or front mounted on a vehicle X, it can capture, respectively, a front-view of a neighboring vehicle that is located behind vehicle X or a rear-view of a neighboring vehicle that is located ahead of vehicle X. While such images may include an image of a license plate, they will also capture part of the exterior body of the neighboring vehicle.

Rather than applying OCR to such images, other image processing algorithms can be applied to determine various structural and/or stylistic attributes (or characteristics) that are helpful for recognition of a vehicle's make and/or model. For purposes of example, assume vehicle X is a subscriber to the service provided by a “Vehicle Recognition App.” The Vehicle Recognition App can be executing as part of application software layer 603. Automatically, or upon command of an occupant of vehicle X, an image “i_1” can be captured of a vehicle “V_1” that is neighboring to vehicle X. Attributes can be determined from i_1 and the values stored in a record “R_1” of a Vehicle-Oriented DB, where R_1 is the record assigned to Vehicle X.

The Vehicle Recognition App and can seek to match the attributes stored in R_1, for a neighboring vehicle V_1, against a “vehicle recognition database.” The vehicle recognition database can store, for example, a record for each of a wide variety of vehicle makes and models. Each “vehicle recognition record,” of the vehicle recognition database, can store attributes, and the levels of such attributes, that need to be found before a match (with a certain confidence level) can be indicated. For each vehicle recognition record “R_2,” that has a sufficient level of match with the attributes of a neighboring vehicle V_1 (as stored in record R_1), the make and/or model indicated by R_2 can be sent, by the Vehicle Recognition App, to the handheld WAN communications device of an occupant of vehicle X. The handheld WAN communications device can display each such make and/or model to the occupant.

3.2.4 License-Plate-Based Addressing

This subsection introduces a new form of vehicle addressing, called “license-plate-based addressing,” for purposes of sending computer-based messaging to the occupants of a vehicle. Stated generally, this license-plate-based addressing can be particularly useful when a person “P” wishes to contact one or more occupants of a vehicle “X,” where P has no other uniquely identifying information available, regarding the occupants of vehicle X, other than the information on Vehicle X's license plate.

License-plate-based addressing relies on information that can be read, from a license plate, when such license plate is read under normal road usage conditions (also referred to herein as “normal license plate information”). Such information typically includes the following:
1. License Plate Number
2. Intra-national issuing authority of the license plate. For the U.S., this is typically the issuing state.
3. Special Status Indicators. These can include the following indicators: Diplomatic status, Government vehicle, or Medical Doctor.

Consider, for example, the situation shown in FIG. 7A. As was discussed above, in connection with FIG. 7A (Section 1 “Vehicle Display of Occupant's Message”), vehicle 100 may “broadcast” a message, on a display of its telematic unit 110, that is seen by the drivers and/or occupants of any of vehicles 710-712. An observer of the message (regardless of whether the observer is in another vehicle or a pedestrian) might wish to respond to the message, for any of a wide variety of purposes.

Vehicle 100 can also display, in addition to the message, instructions for how to send messages to vehicle 100 with license-plate-based addressing (also referred to herein as “messaging instructions”). An example messaging instruction could tell an observer to send a Short Messaging Service (SMS) text message to a particular Short Code (or to a specific keyword provisioned on a Short Code), along with vehicle 100's license plate number and State (if vehicle 100 has U.S. plates). The example messaging instruction could also instruct, as an alternative or additional means, any or all of the following:
sending of an email to a particular email address, with the body or subject line of the email containing vehicle 100's license plate number and State.
use of an application or mobile website, provided with fields into are entered normal license plate information.

An observer of the message may also know how to send messages to vehicle 100 by knowing the product “brand” of telematic unit 110. Brand can be indicated by a any or all of a variety of techniques, including product color and shape. If a brand becomes sufficiently well known and widely used, the observer may already know how to contact a vehicle that is equipped with the product.

Once such message (regardless of whether it is an SMS text message, email, or any other messaging format) is received by hub 300, a process can execute to identify the vehicle record with which it matches (in a Vehicle-Oriented DB), based on any normal license plate information present in the message. This identification process can be executed by the underlying infrastructure of the hub (such as Data Interchange Infrastructure 600) or it can be performed by an App at the application software level.

Assuming a very small number of vehicle records (e.g., 3 or less) can be identified, the contact information in each vehicle record can be used to reach a designated contact person. Specifically, a vehicle's designated contact person can be told that an occupant of a neighboring vehicle, or a pedestrian, wishes to make contact. If the designated contact person responds affirmatively, an initial “connection” can be created, between the designated contact person and the observer. An initial connection can be limited, in any of a variety of appropriate ways, including any combination of the following: further identifying information provided to either party, temporal duration, number of message exchanges.

3.2.4.1 A Specific Example

As a more specific example, consider the following step-by-step scenario for FIG. 7A:
1. driver of vehicle 712 observes the message “Go Team Xyz!” on telematic unit 110 of vehicle 100.
2. Assume the driver of vehicle 712 wishes to tell the occupants of vehicle 100 that he or she also supports Team Xyz.
3. Assume that telematic unit 110 alternates its display, between showing the team message and showing the following messaging instruction: “connect with me by texting my license no. and state to 54321” (where “54321” is a Short Code and the instructions may be shown through a scrolling display).
4. Assume the driver of vehicle 712 observes the license plate of vehicle 100 to be from the State of California, U.S.A., with License Plate No. 1ABC234.
5. Using her cell phone, the driver of vehicle 712 texts “1ABC234” to Short Code 54321.
6. Although the driver of vehicle 712 did not include State of California identifying information in the text (such as “CA”), we will assume that hub 300 is still able to identify a single record, such as record 610 of FIG. 6B.
7. Using the email address of field 628, hub 300 sends a “push” email message to a device 120 (such as that shown in FIG. 1D) that is being held by the driver of vehicle 100 (we will assume that device 120 is a handheld smart-WAN communications device). Although hub 300 has the “caller ID” of the driver of vehicle 712, it automatically creates an anonymous identity for her by assigning a system-generated generic ID, such as “person-nearby-0001.”
8. Driver of vehicle 100 observes the following notification: “person-nearby-0001 wishes to connect with you, do you accept?”
9. Assuming the driver of vehicle 100 answers in the affirmative, hub 300 automatically creates an anonymous identity, for the driver of vehicle 100, by assigning him a system-selected phone number, to which the driver of vehicle 712 can directly send further texts. Assume the system-selected phone number is: 1-888-123-4567.
10. Driver of vehicle 712 receives the following text message notification: “Driver of car with CA License Plate No. 1ABC234 accepts your request to connect. You can directly exchange texts with this person, for the next 5 minutes, at 1-888-123-4567.”
11. Driver of vehicle 712 texts, to 1-888-123-4567, the following message: “Thanks for connecting. Yes, I think Team Xyz is great too!”
12. Driver of vehicle 100 receives the text of support as a push email, identified as being from person-nearby-0001.
13. If the driver of vehicle 100 wishes, he can send a reply message to person-nearby-0001.
14. If the drivers of the two vehicles so desire, they can exchange more permanent contact information, during the course of their initial connection. If not, the connection established by hub 300 simply terminates after 5 minutes.

3.2.4.2 Neither Vehicle Needs A Telematic Unit

While the above discussion of license-plate-based addressing has assumed that the vehicle being contacted (e.g., vehicle 100 of FIG. 7A) has a telematic unit, it should be noted that the above-described communications can occur even if neither vehicle has a telematic unit. For example, rather than having a telematic unit 110, vehicle 100 could simply have a passive indicator (e.g., a “bumper sticker”), indicating that it is open to receiving messages with license-plate-based addressing. Or, vehicle 100 could have no indicators that it is receptive to license-plate-based addressing, but the driver of the contacting vehicle (e.g., vehicle 712) could already know the procedure for license-plate-based addressing (e.g., if the procedure for license-plate-based addressing is part of a well-known brand) and simply test whether vehicle 100 is registered under this system.

3.2.4.3 With Automated License Plate Reading

Under a modified scenario, for usage of license-plate-based addressing, automated license plate reading, as described above (Section 3.2.2 “Automated License Plate Reading”), can be used to make it easier for a party to request a connection to another vehicle. As was discussed above, with respect to FIGS. 8A and 8B, once a license plate image is captured, its textual information can be automatically extracted. An occupant “O_1,” of the vehicle wishing to make contact, can then accomplish contact in the same manner described above in this Section 3.2.4 (“License-Plate-Based Addressing”), except for the following:
O_1 does not need to be able to read the normal license plate information with his or her own eyes; and
O_1 does not need to manually enter the license plate information (such as by typing on a keyboard or by voice command).

3.2.5 Vehicle Proximity Detection

Hub 300 can be used to automatically detect if two (or more) telematically-equipped vehicles are within close proximity to each other. For example, a “Proximity Detection App” can be continuously executing at application software layer 603. It can be accessing records, of Vehicle-Oriented DB 601, for the purpose of comparing their GPS coordinates. Upon detecting two (or more) vehicles as sufficiently close, a message can be sent to the handheld WAN communications device for each vehicle. The message can relay any appropriate information, such as the fact that other hub-connected vehicles are nearby and, perhaps, contact information for such vehicles.

FIG. 7B shows, as an example result of proximity detection, that vehicles 100 and 712, once notified of their proximity to each other, can use their WAN connections to communicate with each other.

3.2.6 Vehicle Location Tracking

There are many circumstances where the owner, or other associated person, of a telematically-equipped vehicle “X,” may wish to track the location of vehicle X. An example (and unfortunate) circumstance is where vehicle X has been stolen. In this case, the owner of vehicle X will wish to track the location of his stolen vehicle and to relay such information to an appropriate law-enforcement agency/department. A vehicle tracking App can operate as follows.

First, it is assumed that Data Interchange Infrastructure 600 is updating a record “R1” (of a Vehicle-Oriented DB) for vehicle X approximately continuously (e.g., in a “push” mode). It is also assumed that an on-board telematic unit of vehicle X has a GPS receiver and, therefore, GPS coordinates for vehicle X are approximately continuously updated in record R1. Under these assumptions, a vehicle tracking App can be implemented very simply. The GPS coordinates for vehicle X need to be frequently accessed and such information transmitted (in some appropriate form) to the appropriate handheld Smart-WAN communications device (e.g., to the handheld device of vehicle X's owner). Once at the Smart-WAN communications device, for example, the GPS coordinates can be plotted on a map and displayed on a screen of the handheld device.

3.2.7 Vehicle Maintenance Tracking

A “maintenance App” can execute at application software layer 603. This App can automatically monitor any, or all, of a variety of sensor readings, to determine when a vehicle X may be in need of maintenance. For example, many vehicles are required by their manufacturers to undergo a specific kind of servicing depending upon the vehicle's odometer reading and/or the time elapsed since the last service visit. Upon undergoing a service visit, the owner of vehicle X can enter the date of such visit with the maintenance App. The maintenance App can note vehicle X's odometer reading, at the time of entry of the service visit. The maintenance App can then proceed to monitor both the elapse of time and the increase in the odometer reading. When the first of the elapsed time or the odometer reading reaches the next manufacturer-specific threshold, the maintenance App can automatically send a reminder message to the handheld Smart-WAN communications device of vehicle X's owner.

### 4 Glossary of Selected Terms

API: Application Programming Interface
display unit (or sometimes just “display”): example display units discussed herein include: display unit 111 of rear-mounted telematic unit 110, display unit 131 of front-mounted telematic unit 130, and optional second display unit 430 of rear-mounted telematic unit 110. Wherever a “display unit” is referenced herein, unless the context indicates otherwise, it should be understood that the display can be of any suitable configuration (e.g., bit-mapped, segmented, or vector) or type (e.g., reflective or illuminated). Further, the display unit can produce and/or reflect its visible radiation through any suitable technology or technologies (e.g., e-ink microspheres, LCD, LED, florescent, laser, incandescent, etc.).
GPS: Global Positioning System
handheld WAN communications device: a handheld communications device that has Wide Area Network (WAN) capability. An example of this type of device, in no way intended to be limiting, is a cellular telephone. If the handheld WAN communications device can execute application software, we can refer to it herein as a “handheld smart-WAN communications device.” Such application software can perform “personal digital assistant” functions, such as provision of address and appointment “books.”
hub: Also called a “data and communication center.” Provides a centralized location with which the telematic units, operating on a large number of vehicles, can interchange data. For example, data collected by telematic units can be uploaded to the hub. Conversely, data to control an effector of a telematic unit (e.g., to cause a particular message to be displayed or to have a particular sound produced) can be downloaded from the hub. The hub also provides a centralized platform for data processing, such as by application software. The application software can rely on the fact that it has access to data uploaded from multiple vehicles and/or the fact that it can control effectors of multiple vehicles.
Interchange data: Unless the context indicates otherwise, data interchange, as used herein, covers any combination of the following modes of data exchange, between a first and second location:

1. transmission from the first location to the second location;

2. transmission from the second location to the first location;

3. transmission in both directions.
On-Board Data II (also known as OBD-II or OBD2): a standard, for all vehicles sold within the U.S., by which data interchange, with a vehicle's on-board computers, is made available for use by equipment not necessarily produced by the vehicle's manufacturer. The OBD-II standard is maintained by the SAE. Through a standardized connector and signaling protocol, OBD-II makes available health and status information for various vehicle sub-systems, including the following:
   factors indicative of engine's health
   odometer value
   whether airbag deployed

An OBD-II connector is required to be within two feet of the steering wheel and accessible from the passenger compartment.
Smart Phone: A type of handheld smart-WAN communications device (defined above under “handheld WAN communications device”). Specifically, the WAN capability of a Smart Phone includes, at least, cellular telephone network capability.
SAE: Society of Automotive Engineers. A professional organization with a place of business in Warrendale, Pa., U.S.A.
Telematics: As used herein, telematics refers to any type of system, incorporating telecommunications and/or information processing, that has been specifically adapted for a vehicular environment. Typically, telematics is understood to be in connection with land vehicles. Some example vehicle types include: automobiles, trucks, recreational vehicles and motorcycles. However, telematics can also apply to vehicles that fly (e.g., fixed-wing craft and helicopters) as well as aquatic vehicles (e.g., boats).
Telematic Unit Any apparatus that has been specifically adapted for use as part of a telematic system.
WLAN: Wireless Local Area Network.

For any method, procedure or technique described above, to the extent it is implemented as the programming of a computer or other data processing system, it can also be described as a computer program product. A computer program product can be embodied on any suitable computer-readable medium or programmable memory. The information (such as data and/or instructions) stored on computer-readable media or programmable memories can be accessed through the use of computer-readable code devices embodied therein. A computer-readable code device can represent that portion of a device wherein a defined unit of information (such as a bit) is stored and/or read.

While the invention has been described in conjunction with specific embodiments, it is evident that many alternatives, modifications and variations will be apparent in light of the foregoing description. Accordingly, the invention is intended to embrace all such alternatives, modifications and variations as fall within the spirit and scope of the appended claims and equivalents.

What is claimed is:

1. A method for social interaction, comprising:
entering a first alphanumeric message, into a first handheld device, by a first occupant of a first vehicle, wherein the first handheld device is capable of sending and receiving messages via a wide area network;
transmitting wirelessly the first message to a first apparatus located on-board the first vehicle; and
displaying the first message, on a first display device coupled to the first apparatus, such that the first message is viewable by a second person who is not an occupant of the first vehicle.

2. The method of claim 1, further comprising:
selecting, performed by a first data and communication center, of a record representing a first advertisement, wherein the first advertisement record is part of a first database that contains a plurality of advertisement records;
transmitting the first advertisement to the first apparatus; and
displaying the first advertisement, on a display device coupled to the first apparatus, such that the first advertisement is viewable by a person who is not an occupant of the first vehicle.

3. The method of claim 2, wherein the first advertisement is displayed on the first display device along with the first message, according to a time-multiplexing procedure.

4. The method of claim 2, wherein the first advertisement is displayed on a second display device coupled to the first apparatus, such that the first advertisement and the first message can be viewed at the same time.

5. The method of claim 1, wherein the second person is an occupant of a second vehicle.

6. The method of claim 5, wherein at least a first portion of the first apparatus, that includes the first display device, is located such that the first message is viewable when the second vehicle is located behind the first vehicle.

7. The method of claim 5, wherein at least a first portion of the first apparatus, that includes the first display device, is located such that the first message is viewable when the second vehicle is located ahead of the first vehicle.

8. The method of claim 7, further comprising the following step:
transposing the first message such that, when read as a reflection in a mirror, it appears as not transposed.

9. The method of claim 1, wherein at least a first portion of the first apparatus, that includes the first display device, is part of a first license plate frame of the first vehicle.

10. The method of claim 1, wherein at least a first portion of the first apparatus, that includes the first display device, is part of a first bumper of the first vehicle.

11. The method of claim 1, wherein at least a first portion of the first apparatus, that includes the first display device, is located such that the first display device is viewable through a rear window of the first vehicle.

12. The method of claim 1, wherein the entering is accomplished with a voice-to-text capability that is executing on the first handheld device.

13. The method of claim 1, wherein the entering is accomplished with an alphanumeric keypad on the first handheld device.

14. The method of claim 1, wherein the step of transmitting is accomplished with a wireless local area network, to which are connected the first handheld device and the first apparatus.

15. The method of claim 14, wherein the wireless local area network conforms to an IEEE 802.11 standard.

16. The method of claim 1, wherein the step of transmitting further comprises:
transmitting the first message to a cellular communications network; and
receiving the first message with the first apparatus, wherein the first apparatus receives the first message via a cellular communications network.

17. The method of claim 16, wherein the first message is sent as an email.

18. The method of claim 16, wherein the first message is sent as a short-message-service message.

19. An apparatus for social interaction, comprising:
a first handheld device into which can be entered, by a first occupant of a first vehicle, a first alphanumeric message, and the first handheld device is capable of sending and receiving messages via a wide area network; and
a first apparatus located on-board the first vehicle, that can wirelessly receive the first message and display the first message on a first display device, wherein the first message is viewable by a second person who is not an occupant of the first vehicle.

20. A computer program product comprising a computer usable medium having computer readable code embodied therein, the computer program product comprising:
computer readable program code devices configured to cause a computer to effect entering a first alphanumeric message, into a first handheld device, by a first occupant of a first vehicle, wherein the first handheld device is capable of sending and receiving messages via a wide area network;
computer readable program code devices configured to cause a computer to effect transmitting wirelessly the first message to a first apparatus located on-board the first vehicle; and
computer readable program code devices configured to cause a computer to effect displaying the first message, on a first display device coupled to the first apparatus, such that the first message is viewable by a second person who is not an occupant of the first vehicle.
